(19) United States
(12) Patent Application Publication
(10) Pub. No.: US 2025/0055325 A1
(43) Pub. Date: Feb. 13, 2025

(54) Wireless Charging Control and Coordination

(71) Applicant: Apple Inc., Cupertino, CA (US)

(72) Inventors: Jinqian Yu, Campbell, CA (US); William R Walitsch, Fremont, CA (US); Mikhal S De Jesus, Auckland (NZ); Patrin Illenberger, Auckland (NZ); Sherjeel Shehzad, Auckland (NZ); Kevin J. Hartnett, Austin, TX (US); Rex Jungho Hwang, Auckland (NZ); Nan Liu, Sunnyvale, CA (US); Kumar Modepalli, Dublin, CA (US); Kunal Bhargava, Auckland (NZ); Oh Jae Lee, San Ramon, CA (US)

(21) Appl. No.: 18/781,091

(22) Filed: Jul. 23, 2024

Related U.S. Application Data
(60) Provisional application No. 63/518,832, filed on Aug. 10, 2023.

(51) Int. Cl. H02J 50/80; H02J 7/00; H02J 50/10

(52) U.S. Cl. CPC H02J 50/80; H02J 7/00712; H02J 50/10; H02J 2207/20

(57) ABSTRACT

A first wireless power system having a first transmit device and a first receive device is operable in close proximity to a second wireless power system having a second transmit device and a second receive device. Each transmit device includes a respective coil driven by an inverter and measurement circuitry that controls the power transmitting devices to promote coexistence of the nearby systems.

This application claims the benefit of U.S. Provisional Patent Application No. 63/518,832, filed Aug. 10, 2023, which is hereby incorporated by reference herein in its entirety.

### FIELD

This relates generally to power systems, including wireless power systems for charging electronic devices.

### BACKGROUND

In a wireless charging system, a wireless power transmitting device transmits wireless power to a wireless power receiving device. The wireless power receiving device charges a battery and/or powers components using the wireless power. In some conditions, electromagnetic energy from one wireless power transmitter and receiver system can interrupt the transfer of wireless power between another set of wireless power transmitter and receiver.

### SUMMARY

A first wireless power system is operable in close proximity to a second wireless power system. The first wireless power system includes a first power transmitting device such as a first tablet computer that transmits first wireless power signals to a first power receiving device such as a first computer stylus. The second wireless power system includes a second power transmitting device such as a second tablet computer that transmits second wireless power signals to a second power receiving device such as a second computer stylus. The first and second wireless power systems may be in close proximity to each other in some situations, such as when the second tablet computer is placed on top of the first tablet computer.

Each power transmitting device includes a respective coil that is driven by a respective inverter. Each power transmitting device includes respective measurement circuitry that measures the corresponding coil. The measurement circuitry includes a demodulation chain and a power detector. The power detector detects the presence of an external radio-frequency (RF) field produced at the corresponding coil by the other power transmitting device and/or by the corresponding power receiving device. The demodulation chain detects the presence of a beat signal produced on the corresponding coil when both power transmitting devices concurrently transmit signals.

Control circuitry adjusts the inverters of one or both power transmitting devices based on the external RF field and/or the beat signal to coordinate charging between the wireless power systems. The control circuitry may improve coexistence by reducing the power level of the wireless power signals, by controlling the power transmitting devices to transmit the respective wireless power signals using a time division duplexing scheme, and/or by performing frequency dithering, as examples.

### BRIEF DESCRIPTION OF THE DRAWINGS

FIG. 1 is a schematic diagram of an illustrative wireless power system in accordance with some embodiments.

FIG. 2 is a perspective view of an illustrative wireless power system having a wireless power transmitting tablet computer and an associated wireless power receiving computer stylus in accordance with some embodiments.

FIG. 3 is a side view of multiple wireless power systems having respective wireless power transmitting tablet computers and wireless power receiving computer styluses that perform wireless power transfer in close proximity to each other in accordance with some embodiments.

FIG. 4 is a circuit diagram of illustrative wireless power transmitting circuitry in a wireless power transmitting device in accordance with some embodiments.

FIG. 5 is a flow chart of illustrative operations performed by a wireless power transmitting device to charge a wireless power receiving device while promoting coexistence with other nearby wireless power systems in accordance with some embodiments.

FIG. 6 is a flow chart of illustrative operations performed by a wireless power transmitting device to promote coexistence with other nearby wireless power systems using a closed loop power adjustment in accordance with some embodiments.

FIG. 7 is a timing diagram showing how illustrative affecter and affected wireless power systems mitigate charging interruptions when the affecter and affected wireless power systems are charging wireless power receiving devices and are then brought into close proximity in accordance with some embodiments.

FIG. 8 is a timing diagram showing how illustrative affecter and affected wireless power systems mitigate charging interruptions when the affecter wireless power system is charging a first wireless power receiving device and the affected wireless power system begins charging a second wireless power receiving device after already being in close proximity to the affecter wireless power system in accordance with some embodiments.

FIG. 9 is a timing diagram showing how illustrative affecter and affected wireless power systems mitigate charging interruptions when the affected wireless power system enters a sleep cloak mode while in close proximity to the affecter wireless power system in accordance with some embodiments.

FIG. 10 is a timing diagram showing how illustrative affecter and affected wireless power systems mitigate charging interruptions when the affected wireless power system leaves close proximity to the affecter wireless power system in accordance with some embodiments.

FIG. 11 is a flow chart of illustrative operations performed by a wireless power system to mitigate charging interruptions from other nearby wireless power systems using a time division duplexing scheme in accordance with some embodiments.

FIG. 12 is a timing diagram of a time division duplexing scheme used by illustrative first and second wireless power systems to charge respective wireless power receiving devices in accordance with some embodiments.

### DETAILED DESCRIPTION

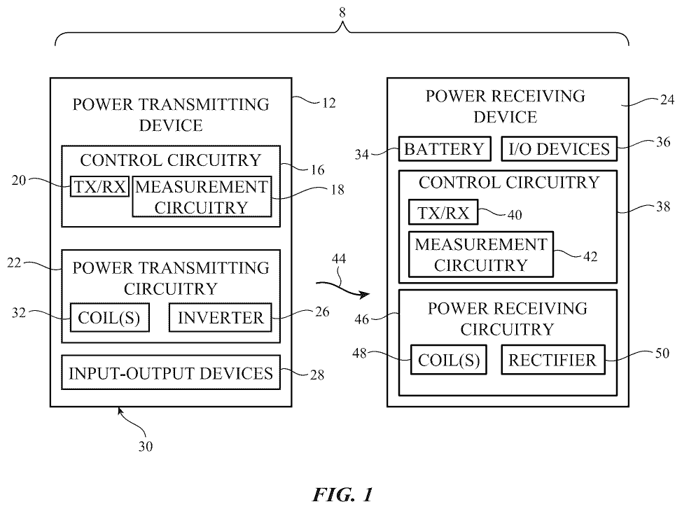

An illustrative wireless power system (also sometimes called a wireless charging system) is shown in FIG. 1. As shown in FIG. 1, wireless power system 8 may include one or more wireless power transmitting devices such as wireless power transmitting device 12 and one or more wireless power receiving devices such as wireless power receiving device 24. Wireless power system 8 may sometimes also be referred to herein as wireless power transfer (WPT) system 8 or wireless power system 8. Wireless power transmitting device 12 may sometimes also be referred to herein as power transmitter (PTX) device 12 or simply as PTX 12. Wireless power receiving device 24 may sometimes also be referred to herein as power receiver (PRX) device 24 or simply as PRX 24.

PTX device 12 includes control circuitry 16. Control circuitry 16 is mounted within housing 30. PRX device 24 includes control circuitry 38 mounted within a corresponding housing for PRX device 24. Exemplary control circuitry 16 and control circuitry 38 are used in controlling the operation of WPT system 8. This control circuitry may include processing circuitry that includes one or more processors such as microprocessors, power management units, baseband processors, digital signal processors, microcontrollers, graphics processing units (GPUs), central processing units (CPUs), application processors (APs), application-specific integrated circuits with processing circuits, and/or other processing circuits. The processing circuitry implements desired control and communications features in PTX device 12 and PRX device 24. For example, the processing circuitry may be used in controlling power to one or more coils, determining and/or setting power transmission levels, generating and/or processing sensor data (e.g., to detect foreign objects and/or external electromagnetic signals or fields), processing user input, handling negotiations between PTX device 12 and PRX device 24, sending and receiving in-band and out-of-band data, making measurements, and/or otherwise controlling the operation of WPT system 8.

Control circuitry in WPT system 8 (e.g., control circuitry 16 and/or 38) is configured to perform operations in WPT system 8 using hardware (e.g., dedicated hardware or circuitry), firmware and/or software. Software code for performing operations in WPT system 8 is stored on non-transitory computer readable storage media (e.g., tangible computer readable storage media) in the control circuitry of WPT system 8. The software code may sometimes be referred to as software, data, program instructions, instructions, or code. The non-transitory computer readable storage media may include non-volatile memory such as non-volatile random-access memory (NVRAM), one or more hard drives (e.g., magnetic drives or solid state drives), one or more removable flash drives or other removable media, or the like. Software stored on the non-transitory computer readable storage media may be executed on the processing circuitry of control circuitry 16 and/or 38.

PTX device 12 may be a stand-alone power adapter (e.g., a wireless charging mat or charging puck that includes power adapter circuitry), may be a wireless charging mat or puck that is connected to a power adapter or other equipment by a cable, may be an electronic device (e.g., a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user's head, or other wearable or miniature device, a television, a computer display that does not contain an embedded computer, a gaming device, a navigation device, a wireless internet-connected voice-controlled speaker, a home entertainment device, a remote control device, a gaming controller, a peripheral user input device, a wireless base station or access point, equipment that implements the functionality of two or more of these devices, or other electronic equipment), may be equipment that has been incorporated into furniture, a vehicle, or other system, may be a removable battery case, or may be other wireless power transfer equipment. Illustrative configurations in which PTX device 12 is an electronic device such as a tablet computer are described herein as an example.

PRX device 24 may be an electronic device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user's head, or other wearable or miniature device, a wireless tracking tag, a television, a computer display that does not contain an embedded computer, a gaming device, a navigation device, a wireless internet-connected voice-controlled speaker, a home entertainment device, a remote control device, a gaming controller, a peripheral user input device, a wireless base station or access point, equipment that implements the functionality of two or more of these devices, or other electronic equipment. Illustrative configurations in which PRX device 24 is a peripheral user input device for PTX device 12 such as a computer stylus are described herein as an example.

PTX device 12 may be connected to a wall outlet (e.g., an alternating current power source), may be coupled to a wall outlet via an external power adapter, may have a battery for supplying power, and/or may have another source of power. In implementations where PTX device 12 is coupled to a wall outlet via an external power adapter, the adapter may have an alternating-current (AC) to direct-current (DC) power converter that converts AC power from a wall outlet or other power source into DC power. If desired, PTX device 12 may include a DC-DC power converter for converting the DC power between different DC voltages. Additionally or alternatively, PTX device 12 may include an AC-DC power converter that generates the DC power from the AC power provided by the wall outlet (e.g., in implementations where PTX device 12 is connected to the wall outlet without an external power adapter). DC power may be used to power control circuitry 16. During operation, a controller in control circuitry 16 uses power transmitting circuitry 22 to transmit wireless power to power receiving circuitry 46 of PRX device 24.

Power transmitting circuitry 22 may have switching circuitry, such as inverter circuitry 26 formed from transistors, that are turned on and off based on control signals provided by control circuitry 16 to create AC current signals through one or more wireless power transmitting coils such as wireless power transmitting coil(s) 32. These coil drive signals cause coil(s) 32 to transmit wireless power. In implementations where coil(s) 32 include multiple coils, the coils may be disposed on a ferromagnetic structure, arranged in a planar coil array, or may be arranged to form a cluster of coils (e.g., two or more coils, 5-10 coils, at least 10 coils, 10-30 coils, fewer than 35 coils, fewer than 25 coils, or other suitable number of coils). In some implementations, PTX device 12 includes only a single coil 32.

As the AC currents pass through one or more coils 32, alternating-current electromagnetic (e.g., magnetic) fields (wireless power signals 44) are produced that are received by one or more corresponding receiver coils such as coil(s) 48 in PRX device 24. In other words, one or more of coils 32 is inductively coupled to one or more of coils 48. PRX device 24 may have a single coil 48, at least two coils 48, at least three coils 48, at least four coils 48, or another suitable number of coils 48. When the alternating-current electromagnetic fields are received by coil(s) 48, corresponding alternating-current currents are induced in coil(s) 48. The AC signals that are used in transmitting wireless power may have any suitable frequency (e.g., 100-400 kHz, 1-100 MHz, etc.). Rectifier circuitry such as rectifier circuitry 50, which contains rectifying components such as synchronous rectification transistors arranged in a bridge network, converts received AC signals (received alternating-current signals associated with wireless power signals 44) from one or more coils 48 into DC voltage signals for powering PRX device 24. Wireless power signals 44 are sometimes referred to herein as wireless power 44 or wireless charging signals 44. Coils 32 are sometimes referred to herein as wireless power transfer coils 32 or wireless power transmitting coils 32. Coils 48 are sometimes referred to herein as wireless power transfer coils 48 or wireless power receiving coils 48.

The DC voltage produced by rectifier circuitry 50 (sometime referred to as rectifier output voltage Vrect) can be used in charging a battery such as battery 34 and can be used in powering other components in PRX device 24 such as control circuitry 38, input-output (I/O) devices 36, etc. PTX device 12 may also include input-output devices such as input-output devices 28. Input-output devices 36 and/or input-output devices 28 may include input devices for gathering user input and/or making environmental measurements and may include output devices for providing a user with output.

As examples, input-output devices 28 and/or input-output devices 36 may include a display (screen) for creating visual output, a speaker for presenting output as audio signals, light-emitting diode status indicator lights and other light-emitting components for emitting light that provides a user with status information and/or other information, haptic devices for generating vibrations and other haptic output, and/or other output devices. Input-output devices 28 and/or input-output devices 36 may also include sensors for gathering input from a user and/or for making measurements of the surroundings of WPT system 8. In the example described herein in which PTX device 12 is a tablet computer and PRX device 24 is a computer stylus, input-output devices 28 include a touch and/or force-sensitive display that displays images and that detects PRX device 24 coming into contact with and/or pressing against the display.

The example in FIG. 1 of PRX device 24 including battery 34 is merely illustrative. If desired, an electronic device may include a supercapacitor to store charge instead of a battery. For example, PRX device 24 may include a supercapacitor in place of battery 34. Battery 34 may therefore sometimes be referred to as power storage device 34 or supercapacitor 34.

PTX device 12 and PRX device 24 may communicate wirelessly using in-band or out-of-band communications. Implementations using in-band communication may utilize, for example, frequency-shift keying (FSK) and/or amplitude-shift keying (ASK) techniques to communicate in-band data between PTX device 12 and PRX device 24. Wireless power and in-band data transmissions may be conveyed using coils 32 and 48 concurrently. Wireless transceiver (TX/RX) circuitry 20 may modulate wireless charging signal 44 to impart FSK or ASK communications, and wireless transceiver circuitry 40 may demodulate the wireless charging signal 44 to obtain the data that is being communicated. Implementations using out-of-band communication may utilize, for example, hardware antenna structures and communication protocols such as Bluetooth or NFC to communicate out-of-band data between PTX device 12 and PRX device 24. Power may be conveyed wirelessly during out-of-band data transmissions. Wireless transceiver circuitry 20 may wirelessly transmits and/or receive out-of-band signals to and/or from PRX device 24 using an antenna.

Control circuitry 16 in PTX device 12 has measurement circuitry 18 that may be used to perform measurements of one or more characteristics external to PTX device 12. For example, measurement circuitry 18 may detect external objects on or adjacent the charging surface of the housing of PTX device 12. The charging surface may be formed by a planer outer surface of an upper housing wall or a peripheral sidewall of device 12 or may have other shapes (e.g., concave or convex shapes, etc.). While shown in FIG. 1 as being separate from power transmitting circuitry 22 for the sake of clarity, measurement circuitry 18 may form a part of power transmitting circuitry 22 if desired.

Measurement circuitry 18 can detect foreign objects such as coils, paper clips, and other metallic objects, can detect the presence of PRX device 24 (e.g., circuitry 18 can detect the presence of one or more coils 48 and/or magnetic core material associated with coils 48), and/or can detect the presence of other power transmitting devices in the vicinity of PTX device 12 and/or WPT system 8. Measurement circuitry 18 can also be used to make sensor measurements using a capacitive sensor, can be used to make temperature measurements, and/or can otherwise be used in gathering information indicative of whether a foreign object, power transmitting device, power receiving device, or other external object (e.g., PRX device 24) is present on or adjacent to the coil(s) 32 of PTX device 12. If desired, PRX device 24 may include measurement circuitry 42. Measurement circuitry 42 may perform one or more of the measurements performed by measurement circuitry 18 (e.g., for or using coil(s) 48 on PRX device 24).

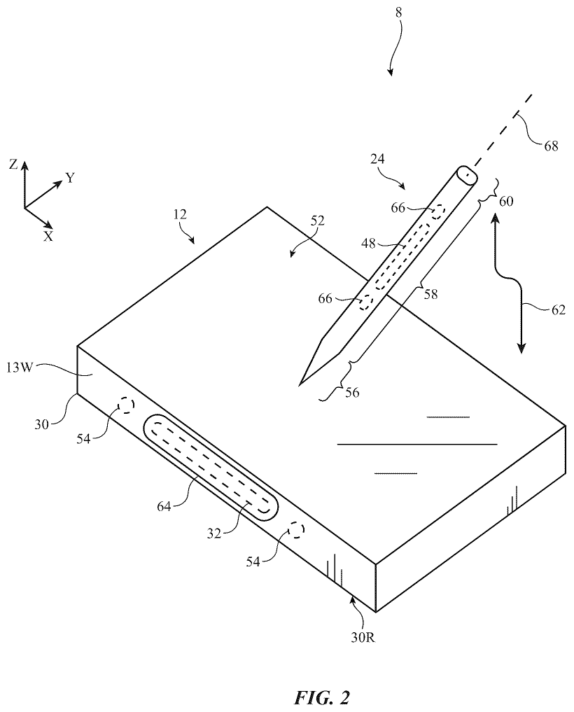

FIG. 2 is a perspective view showing how PRX 24 can interact with PTX 12 in an illustrative configuration where PTX device 12 is a tablet computer or other device with a touch screen and PRX device 24 is a computer stylus. The computer stylus may be paired with the tablet computer. A user can use the computer stylus (e.g., PRX device 24) to draw or write on the tablet computer (e.g., PTX device 12) and to provide other input to the tablet computer.

As shown in FIG. 2, PTX device 12 includes a housing such as housing 30. PTX device 12 also includes a display 52 mounted to housing 30. Display 52 may be a capacitive touch screen display or a display that includes other types of touch sensor technology. The touch sensor of display 52 may be configured to receive input from a computer stylus (e.g., PRX device 24). If desired, display 52 may also be sensitive to force (e.g., may generate a force sensor input indicative of how hard PRX device 24 is pressing against display 52).

Display 52 may be a touch screen display that incorporates a layer of conductive capacitive touch sensor electrodes or other touch sensor components (e.g., resistive touch sensor components, acoustic touch sensor components, force-based touch sensor components, light-based touch sensor components, etc.) or may be a display that is not touch-sensitive. Capacitive touch screen electrodes may be formed from an array of indium tin oxide pads or other transparent conductive structures.

Display 52 may have an active area that includes an array of display pixels. The array of pixels may be formed from liquid crystal display (LCD) components, an array of electrophoretic pixels, an array of plasma display pixels, an array of organic light-emitting diode display pixels or other light-emitting diode pixels, an array of electrowetting display pixels, or display pixels based on other display technologies.

PRX device 24 may have a cylindrical shape or other elongated body that extends along longitudinal axis 68. The body of PRX device 24 may be formed from metal and/or plastic tubes and other elongated structures. Wireless transceiver circuitry 20 in PTX device 12 and wireless transceiver circuitry 40 in PRX device 24 (FIG. 1) may support wireless communications via wireless communications link 62 (e.g., a Bluetooth link). As an example, PRX device 24 may supply wireless input to PTX device 12 via link 62 (e.g., information on settings in a drawing program or other software running on PTX device 12, input to select a desired on-screen option, input to supply PTX device 12 with a touch gesture such as a stylus flick, input to draw a line or other object on display 52, input to move or otherwise manipulate images displayed on display 52, etc.).

PRX device 24 may have a tip portion such as tip 56. Tip 56 may contain a conductive elastomeric member that is detected by the capacitive touch sensor of display 52. If desired, tip 56 may contain active electronics (e.g., circuitry that transmits signals that are capacitively coupled into the touch sensor of display 52 and that are detected as touch input on the touch sensor).

Shaft portion 58 of PRX device 24 may couple tip 56 of PRX device 24 to the opposing end 60 of PRX device 24. End 60 may contain a conductive elastomeric member, active electronics (e.g., circuitry that transmits signals that are capacitively coupled into the touch sensor of display 52 and that are detected as touch input on the touch sensor), buttons, a metal connector that mates with an external plug, an antenna (e.g., for supporting link 62), and/or other input-output components.

If desired, a force sensor may be incorporated into tip 56 and/or opposing end 60 of PRX device 24. A force sensor may be used to measure how forcefully a user is pressing PRX device 24 against the outer surface of display 52. Force data may then be wirelessly transmitted from PRX device 24 to PTX device 12 (e.g., using link 62) so that the thickness of a line that is being drawn on display 52 can be adjusted accordingly or so that PTX device 12 may take other suitable action.

If desired, PRX device 24 may be provided with a clip to help attach PRX device 24 to a user's shirt pocket or other object, may be provided with a magnet to help attach PRX device 24 to a magnetic attachment point in PTX device 12 or other structures, and/or may be provided with other structures that help a user attach PRX device 24 to external objects. End 60 may have a removable cap, a data port connector to receive a cable (e.g., a cable that supplies power signals for charging a battery in PRX device 24 and/or that supplies digital data), input-output devices (e.g., a button and/or a light-emitting diode or other light-based output device), or other components (e.g., metal structures). Other components may be formed on PRX device 24 (e.g., on shaft 58 or elsewhere) such as buttons, touch sensors, and other components for gathering input, light-emitting diodes or other components for producing output, etc.

PRX device 24 may include a metal tube or other conductive components in shaft portion 58. The metal tube or other structures in PRX device 24 may serve as an antenna ground for one or more antennas in PRX device 24. An antenna resonating element for the antenna may be formed from metal traces on a printed circuit or other dielectric support structure and/or from other conductive structures. An antenna resonating element may be located in end region 60, along shaft 58, in tip region 56, or in other suitable portions of PRX device 24. The antenna may be used to support wireless link 62. One or more wireless power receiving coils such as coil 48 may be disposed along shaft 58. Coil 48 may be covered by a dielectric outer tube or cover layer that forms the housing or exterior of PRX device 24. If desired, PRX device 24 may include one or more attachment structures such as magnets 66. Magnets 66 may help to secure PRX device 24 to a suitable portion of PTX device 12 during wireless power transfer (sometimes referred to herein as wireless charging).

Housing 30 of PTX device 12, which may sometimes be referred to as an enclosure or case, may be formed of plastic, glass, ceramics, fiber composites, metal (e.g., stainless steel, aluminum, etc.), other suitable materials, or a combination of any two or more of these materials.

Housing 30 may be formed using a unibody configuration in which some or all of housing 30 is machined or molded as a single structure or may be formed using multiple structures (e.g., an internal frame structure, one or more structures that form exterior housing surfaces, etc.). In the example of FIG. 2, housing 30 includes a peripheral conductive sidewalls 30W that surround the lateral periphery of PTX device 12 and display 52. Housing 30 may, if desired, include a conductive rear wall 30R that opposes display 52 (e.g., conductive rear wall 30R may form the rear exterior face, side, or surface of PTX device 12). If desired, rear wall 30R and sidewalls 30W may be formed from a continuous metal structure (e.g., in a unibody configuration) or from separate metal structures. Openings may be formed in housing 30 to form communications ports, holes for buttons, and other structures if desired. In another suitable arrangement, rear wall 30R and/or sidewalls 30W may be formed from dielectric materials such as ceramics, plastic, or glass.

Display 52 may be protected using a display cover layer such as a layer of transparent glass, clear plastic, transparent ceramic, sapphire, or other transparent crystalline material, or other optically transparent layer(s). The display cover layer may have a planar shape, a convex curved profile, a shape with planar and curved portions, a layout that includes a planar main area surrounded on one or more edges with a portion that is bent out of the plane of the planar main area, or other suitable shapes. The display cover layer may cover the entire front face of PTX device 12 (e.g., extending across an entirety of a length dimension of PTX device 12 parallel to the X-axis and a width dimension of PTX device 12 parallel to the Y-axis of FIG. 2). Sidewalls 30W may extend from a rear face of PTX device 12 formed by rear wall 30R to the display cover layer (e.g., extending across a height dimension of PTX device 12 parallel to the Z-axis of FIG. 2). In another suitable arrangement, the display cover layer may cover substantially all of the front face of PTX device 12 or only a portion of the front face of PTX device 12. Openings may be formed in the display cover layer. For example, an opening may be formed in the display cover layer to accommodate a button, speaker, fingerprint sensor, etc. One or more antennas for supporting wireless communications link 62 may be mounted within housing 30.

Housing 30 may have four peripheral edges (e.g., conductive sidewalls 30W). One or more wireless power transmitting coils such as coil 32 may be mounted within housing 30, behind display 52, and adjacent to a housing sidewall 30W such as at a location overlapping region 64 of FIG. 2. In scenarios where housing sidewalls 30W are formed from conductive material, a dielectric window may be formed within the sidewalls (e.g., region 64 may form a dielectric window in sidewall 30W for coil 32). Coil 32 is mounted behind the dielectric window to allow wireless power to be transferred to PRX device 24 when PRX device 24 is placed adjacent to the dielectric window. If desired, PTX device 12 may include one or more attachment structures such as magnets 54 located along, adjacent, or overlapping region 64. Magnets 54 and/or magnets 66 can help to secure PRX device 24 in place against region 64 of sidewall 30W during wireless charging (e.g., in a position/orientation at which the coil 32 in PTX device 12 is sufficiently aligned with the coil 48 in PRX device 24 so as to maximize wireless power transfer efficiency).

In this example, when it is desired to charge PRX device 24, a user places PRX device 24 against sidewall 30W (e.g., with longitudinal axis 68 of PRX device 24 extending parallel to the X-axis of FIG. 2). Magnets 54 and/or 66 may snap PRX device 24 against sidewall 30W and may hold PRX device 24 in place (e.g., at an optimal position/orientation for maximizing wireless power transfer efficiency). When PRX device 24 is placed adjacent or against region 64, coil 32 on PTX device 12 is aligned with the coil 48 on PRX device 24. Coil 32 then transmits wireless power (e.g., wireless power signals 44 of FIG. 1) to coil 48 for powering or charging PRX device 24.

This example is illustrative and non-limiting. In general, coil 32 may be disposed at any desired location within PTX device 12. For example, coil 32 may be disposed within PTX device 12 at a location overlapping display 52 (e.g., for charging PRX device 24 through an inactive region of display 52 while the PRX device rests on the inactive region), at a location overlapping other sidewalls 30W of PTX device 12, and/or at a location overlapping rear wall 30R (e.g., for charging PRX device 24 through a dielectric portion or window of rear wall 30R while the PRX device rests on rear wall 30R). If desired, PTX device 12 may include multiple coils 32 at different locations within PTX device 12. If desired, two or more coils 32 in PTX device 12 may be at least partially overlapping with respect to each other within the same region of PTX device 12.

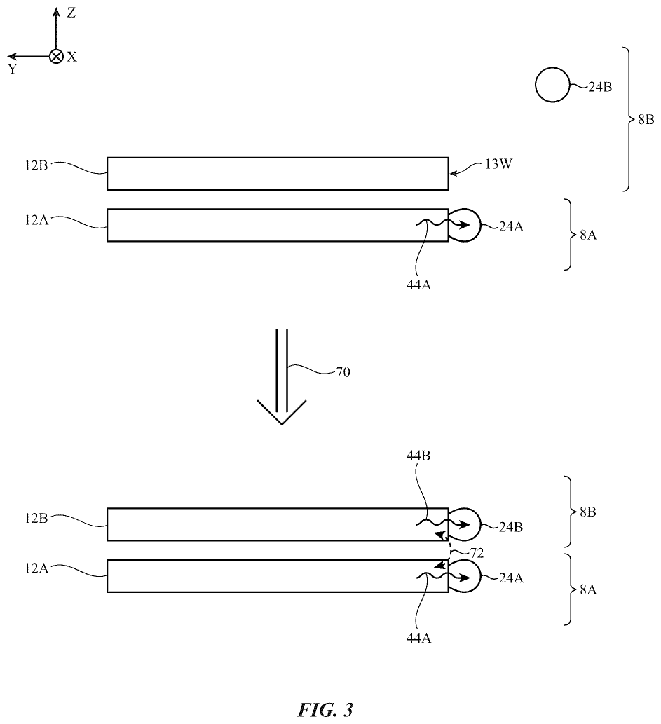

During operation, situations may arise in which a given WPT system 8 comes into close proximity with an additional (external) WPT system 8. FIG. 3 is a side view (e.g., as viewed in the +X direction of FIG. 2) showing one such situation. As shown in FIG. 3, there may be a first WPT system 8A that includes a first PTX device 12A (e.g., a first tablet computer) and a first PRX device 24A (e.g., a first computer stylus that is paired with the first tablet computer). There may also be a second WPT system 8B that includes a second PTX device 12B (e.g., a second tablet computer) and a second PRX device 24B (e.g., a second computer stylus that is paired with the second tablet computer but not the first tablet computer). WPT system 8B may be located in close proximity to WPT system 8A (e.g., within 10 mm, such as when PTX device 12A is resting on an underlying surface such as a desktop or tabletop and PTX device 12B has been placed on top of PTX device 12A).

As shown in FIG. 3, at an initial time, a user (e.g., the user of WPT system 8A and/or WPT system 8B) mounts PRX device 24A to (against) the sidewall 30W of PTX device 12A (e.g., overlapping region 64 of FIG. 2). Magnets 54 and/or 66 or other alignment and/or attachment structures help to hold PRX device 24A in place against the sidewall 30W of PTX device 12A. PTX device 12A transmits wireless power signals 44A to PRX device 24A through sidewall 30W while PRX device 24A is mounted to sidewall 30W. Power receiving circuitry 46 (FIG. 1) on PRX device 24A charges battery 34 and/or powers the components of PRX device 24A using wireless power signals 44A.

At the initial time, the PRX device 24B of WPT system 8B is not mounted to PTX device 12B. As such, PTX device 12B does not transmit wireless power signals to PRX device 24B. However, as shown by arrow 70, a user (e.g., the user of WPT system 8A and/or WPT system 8B) may mount PRX device 24B to the sidewall 30W of PTX device 12B at a later time. Magnets 54 and/or 66 (FIG. 2) or other alignment and/or attachment structures help to hold PRX device 24B in place against the sidewall 30W of PTX device 12B. PTX device 12B transmits wireless power signals 44B to PRX device 24B through sidewall 30W while PRX device 24B is mounted to sidewall 30W. Power receiving circuitry 46 (FIG. 1) on PRX device 24B charges battery 34 and/or powers the components of PRX device 24B using wireless power signals 44B.

PTX device 12B may transmit wireless power signals 44B to PRX device 24B concurrent with PTX device 12A transmitting wireless power signals 44A to PRX device 24A. When WPT system 8B is in close proximity to (e.g., within 10 mm of) WPT system 8A, the concurrent transmission of wireless power signals 44A and 44B can cause undesired interruptions to wireless power transfer to PRX device 24B and/or PRX device 24A. For example, as shown by arrow 72, at least some of the electromagnetic energy associated with wireless power signals 44B can leak onto WPT system 8A (e.g., the coil 32 in PTX device 12A and/or the coil 48 in PRX device 24A) and/or at least some of the electromagnetic energy associated with wireless power signals 44A can leak onto WPT system 8B (e.g., the coil 32 in PTX device 12B and/or the coil 48 in PRX device 24B).

This neighboring electromagnetic energy can produce electromagnetic beating on the coil 32 of PTX device 12A and/or on the coil 32 of PTX device 12B. The electromagnetic beating is given by the superposition or interference of the electromagnetic energy and the wireless power signals when at slightly different frequencies (e.g., where constructive and destructive interference between both signals produces an envelope in the superposed signal that forms the electromagnetic beating at a corresponding beat (envelope) frequency). The electromagnetic beating produces fluctuations in the wireless power signals transmitted by the coil at the corresponding beat frequency. The beat frequency can cause one or both WPT systems 8 to stop wireless power transfer, which extends the time required to charge PRX devices 24A and/or 24B.

For example, when wireless power transfer is interrupted, the PTX device of a given WPT system 8 resets (restarts) wireless power transmission. This reset generally occurs randomly in the presence of the beating and causes the PRX device to take a longer amount of time to fully charge. In addition, if an excessive number of resets occur in a given time period, the PTX device may forego wireless power transmission or may enter a repeated reset loop, preventing the PRX device from being charged altogether. In other words, one or more of the WPT systems may experience lengthened charge times.

When located in close proximity, one of WPT systems 8A and 8B can act as an affecter system whereas the other of WPT systems 8A and 8B acts as an affected system during wireless power transfer. The affecter system transmits wireless power signals 44 that can reduce wireless charging performance of the affected system. Affecter systems are sometimes called aggressor systems or aggressors, and affected systems are sometimes called victim systems or victims.

In general, the relative timing of wireless power transfer by WPT systems 8A and 8B and/or the power transmission characteristics of WPT systems 8A and 8B will determine whether a given WPT system 8 is an affecter system or an affected system at a given time (e.g., the WPT system 8 that is the affecter system or the WPT system 8 that is the affected system may change over time). For the sake of illustration, situations in which WPT system 8A acts as an affecter system and WPT system 8B acts as an affected system are sometimes described herein as an example. WPT system 8A may therefore sometimes also be referred to herein as affecter system 8A or affecter WPT system 8A whereas WPT system 8B is sometimes also referred to herein as affected system 8B or affected WPT system 8B.

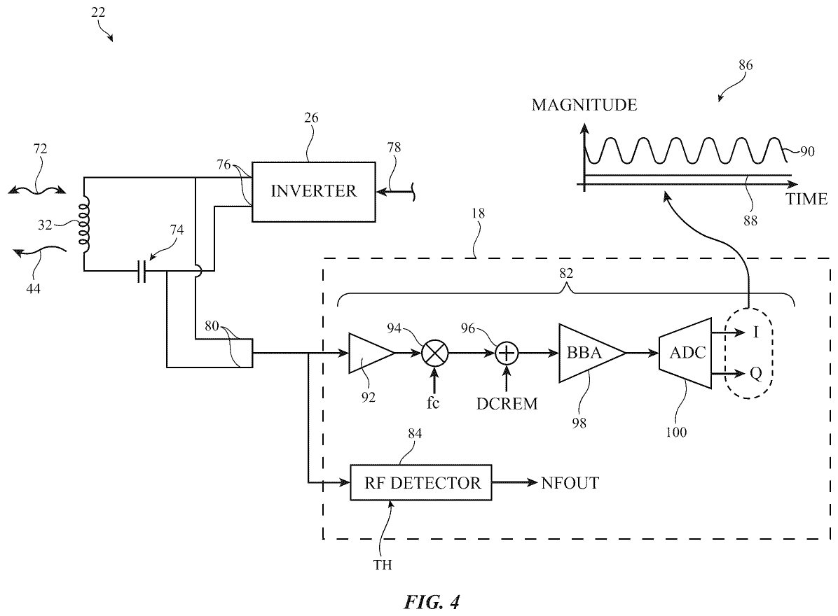

FIG. 4 is a circuit diagram of illustrative wireless power transmitting circuitry 22 in a given PTX device 12 (e.g., PTX device 12A or PTX device 12B of FIG. 3). As shown in FIG. 4, wireless power transmitting circuitry 22 may include inverter circuitry such as one or more inverters 26 or other drive circuitry that produces wireless power signals 44 that are transmitted through an output circuit that includes one or more coils 32 and capacitors such as capacitor 74. Inverter(s) 26 may, for example, have output terminals 76. Coil 32 may be coupled between output terminals 76. One or more capacitors such as capacitor 74 may be coupled in series between coil 32 and one or both output terminals 76. Only a single series capacitor 74 is shown in FIG. 4 for the sake of clarity. If desired, one or more parallel capacitors (not shown) may be coupled between output terminals 76.

In some embodiments, wireless power transmitting circuitry 22 may include multiple individually controlled inverters 26, each of which supplies drive signals to a respective coil 32. In other embodiments, an inverter 26 is shared between multiple coils 32 using switching circuitry. In other embodiments, wireless power transmitting circuitry 22 includes a single coil 32 driven by one or more inverters 26.

During wireless power transmission operations, transistors in inverter(s) 26 are driven by AC control signals received at control input 78 from control circuitry 16 (FIG. 1). The application of drive signals using inverter(s) 26 (e.g., transistors or other switches) causes the output circuits formed from coil 32 and capacitor(s) 74 to produce alternating-current electromagnetic fields (e.g., wireless power signals 44) that are received by one or more coils 48 on the corresponding PRX device 24.

As previously mentioned, in-band transmissions using coils 32 and 48 (FIG. 1) may be used to convey (e.g., transmit and receive) information between devices 12 and 24. With one illustrative configuration, frequency-shift keying (FSK) is used to transmit in-band data from PTX device 12 to PRX device 24 and amplitude-shift keying (ASK) is used to transmit in-band data from PRX device 24 to PTX device 12. In other words, a device transmitting wireless power may use FSK to transmit in-band data to a device receiving wireless power. A device receiving wireless power may use ASK to transmit in-band data to a device transmitting wireless power.

Power may be conveyed wirelessly from PTX device 12 to the corresponding PRX device 24 during these FSK and ASK transmissions. While wireless power transmitting circuitry 22 is driving AC signals into coil 32 to produce wireless power signals 44 at the power transmission frequency, wireless transceiver circuitry 20 (FIG. 1) may use FSK modulation to modulate the power transmission frequency of the driving AC signals and thereby modulate the frequency of wireless power signals 44. In PRX device 24, coil 48 is used to receive wireless power signals 44. Power receiving circuitry 46 (FIG. 1) uses the received signals on coil 48 and rectifier 50 to produce DC power. At the same time, wireless transceiver circuitry 40 monitors the frequency of the AC signal passing through coil(s) 48 and uses FSK demodulation to extract the transmitted in-band data from wireless power signals 44. This approach allows FSK data (e.g., FSK data packets) to be transmitted in-band from PTX device 12 to PRX device 24 with coils 32 and 48 while power is simultaneously being wirelessly conveyed from PTX device 12 to PRX device 24 using coils 32 and 48.

In-band communications between device 24 and device 12 may use ASK modulation and demodulation techniques. Wireless transceiver circuitry 40 on PRX device 24 (FIG. 1) transmits in-band data to PTX device 12 by using a switch (e.g., one or more transistors in wireless transceiver circuitry 40 that are coupled coil 48) to modulate the impedance of power receiving circuitry 46 (e.g., coil 48). This, in turn, modulates the amplitude of wireless power signals 44 and the amplitude of the AC signal passing through coil(s) 32. Wireless transceiver circuitry 20 on PTX device 12 (FIG. 1) monitors the amplitude of the AC signal passing through coil(s) 32 and, using ASK demodulation, extracts the transmitted in-band data from these signals that was transmitted by wireless transceiver circuitry 40 on PRX device 24. The use of ASK communications allows ASK data bits (e.g., ASK data packets) to be transmitted in-band from PRX device 24 to PTX device 12 with coils 48 and 32 while power is simultaneously being wirelessly conveyed from PTX device 12 to PRX device 24 using coils 32 and 48.

The example of FSK modulation being used to convey in-band data from PTX device 12 to PRX device 24 and ASK modulation being used to convey in-band data from PRX device 24 to PTX 12 is merely illustrative. In general, any desired communication techniques may be used to convey information from PTX device 12 to PRX device 24 and from PRX device 24 to PTX device 12. In general, wireless power may simultaneously be conveyed between devices during in-band communications (using ASK or FSK).

The power transmission frequency used for transmission of wireless power signals 44 may be, for example, a predetermined frequency of at least 80 kHz, at least 100 kHz, between 100 kHz and 205 kHz, less than 500 kHz, less than 300 kHz, between 100 kHz and 400 kHz, at least 1 MHz, 1-100 MHz, 1-20 MHz, 13.56 MHz, or another suitable wireless power frequency. In some configurations, the power transmission frequency may be negotiated in communications between devices 12 and 24. In other configurations, the power transmission frequency may be fixed.

It has been described that power may be simultaneously conveyed between devices while using in-band communication for data transmission between the devices. In other words, in some examples in-band communications may rely on modulation of the power transmission signal (e.g., modulating the power transmission frequency or modulating amplitude of a signal at the power transmission frequency). However, other communication techniques may be used that do not rely on modulation of the power transmission signals. For example, signals (sometimes referred to as in-band signals) may be conveyed between coils in the system at a frequency that is different than the power transmission frequency. Signals (at the same frequency or a different frequency than the power transmission frequency) that are conveyed using the coils (e.g., coils 32 and 48) may be considered in-band signals.

Moreover, it should be noted that in-band communication may occur between devices before the devices agree upon a power transfer rate, power transmission frequency, etc. After initial detection and inductive coupling, devices may go through a handshake process to determine compatibility, negotiate power transfer frequency, negotiate power transfer rate, etc.

During this process, in-band communication may involve FSK and/or ASK modulation of signals at the power transmission frequency. Therefore, wireless power is transmitted during this process. This is advantageous as it allows the devices to complete the handshake process even if the power receiving device has little or no remaining battery power. This transmission of wireless power during in-band communications may occur during the handshake process even if, ultimately, the negotiations between the devices result in no sustained transmission of wireless power (e.g., even if the devices do not enter a dedicated power transfer phase).

As shown in FIG. 4, wireless power receiving circuitry 22 may be coupled to measurement circuitry 18 in PTX device 12 over paths 80 (sometimes referred to herein as tap paths 80, sensor paths 80, or measurement paths 80). Measurement circuitry 18 may include an in-phase and quadrature-phase (I/Q) demodulation chain such as demodulation chain 82 (sometimes also referred to herein as demodulator 82, demodulator circuitry 82, or demodulator path 82). Measurement circuitry 18 may also include a low power detector such as power detector 84 (e.g., a radio-frequency power detector). The input of demodulation chain 82 and the input of power detector 84 may be coupled to paths 80 in parallel.

Demodulation chain 82 includes an amplifier such as preamplifier 92, mixer circuitry such as mixer 94, adder circuitry such as adder 96, a baseband amplifier (BBA) such as amplifier 98, and an analog-to-digital converter (ADC) such as ADC 100. The input of preamplifier 92 is coupled to paths 80 (e.g., via a signal combiner). The output of preamplifier 92 is coupled to a first input of mixer 94. The second input of mixer 94 receives an oscillating signal at a carrier frequency fc. The output of mixer 94 is coupled to a first input of adder 96. The second input of adder 96 receives a DC removal signal DCREM. The output of adder 96 is coupled to the input of amplifier 98. The output of amplifier 98 is coupled to the input of ADC 100.

Demodulation chain 82 measures signals on coil 32 over paths 80 while inverter 26 transmits wireless power signals 44 over coil 32 (e.g., demodulation chain 82 is active, powered, and/or enabled while coil 32 transmits wireless power signals 44 and is inactive, unpowered, and/or disabled when coil 32 does not transmit wireless power signals 44). During wireless power transmission over coil 32, demodulation chain 82 receives some of the signal on coil 32 over paths 80.

Preamplifier 92 amplifies the signal received over paths 80. Mixer 94 mixes (e.g., down-converts) the amplified signal. Demodulation chain 82 may be an I/Q demodulation chain having a first signal line that carries the in-phase (I) component of the signal received over paths 80 and a second signal line that carries the quadrature-phase (Q) component of the signal received over paths 80. As such, mixer 94 may be an I/Q mixer that mixes the amplified signal with the oscillating signal at carrier frequency fc to output the I component of the signal. At the same time, mixer 94 mixes the amplified signal with a 90-degree phase shifted version of the oscillating signal at carrier frequency fc to output the Q component of the signal.

Adder 96 may be an I/Q adder that removes a DC component from the received signal by adding DC removal signal DCREM to the I component and the Q component of the signal. Amplifier 98 may include a first amplifier that amplifies the I component of the signal after DC removal and may include a second amplifier that amplifies the Q component of the signal after DC removal. ADC 100 may convert the I/Q signal from the analog domain to the digital domain, outputting the signal as a stream of digital I/Q data. Control circuitry 16 (FIG. 1) may perform any desired subsequent processing on the digital I/Q data.

As one example, in the presence of another WPT system 8 in close proximity to coil 32, some of the wireless power transmitted by the PTX device 12 in the other WPT system can be sensed at coil 32 and/or some of the wireless power transmitted by coil 32 may be received at the other WPT system, as shown by arrow 72. The electromagnetic field associated with arrow 72 produced on coil 32 can produce beating in the signal on coil 32 (e.g., envelope fluctuations in the signal magnitude at a corresponding beat frequency). Demodulation chain 82 can measure the beating in the signal received over paths 80.

Plot 86 of FIG. 4 shows the magnitude of the digital I/Q data output by ADC 100 as a function of time. Curve 88 plots the magnitude of the digital I/Q data in the absence of the nearby field associated with arrow 72. Curve 90 plots the digital I/Q data in the presence of the nearby field associated with arrow 72. As shown by curve 90, the nearby field associated with arrow 72 produces beating in the signal on coil 32 (e.g., from the summing of the magnitude of the transmitted wireless power signals 44 and the magnitude of the incident electromagnetic field from the other WPT system at a slightly different frequency). This in turn produces periodic ripples in the magnitude of the digital I/Q data (e.g., at the corresponding beat frequency) measured/output by demodulation chain 82. As such, control circuitry 16 may process the digital I/Q data to detect the beating associated with curve 90. The control circuitry may then use the detection of beating in the digital I/Q data to detect the presence of the other WPT system in close proximity to coil 32. Control circuitry 16 may detect the beating or beat signal in the digital I/Q data using any suitable signal beat detection algorithm or method. As examples, control circuitry 16 may perform beat detection by performing a fast Fourier transform (FFT) on the digital I/Q data to identify a dominant beat frequency element of the digital I/Q data, by calculating the slope/gradient of the digital I/Q data (e.g., for lower frequency signals where only part of the beat waveform is captured by the ADC), by calculating the root mean square (RMS) of the signal relative to the mean and comparing the RMS to a threshold (e.g., where the average difference from the mean is greater than 100 ADC counts), by calculating the peak-to-peak of the digital I/Q data and comparing to a threshold, and/or by calculating the phase between the digital I/Q signals, where the phase is random in the presence of noise (e.g., in the absence of beating) and approximately 90 degrees in the presence of beating. Additionally or alternatively, demodulation chain 82 may perform ASK demodulation of the signals on coil 32 (e.g., for receiving in-band communications from the corresponding PRX device 24).

Power detector 84 also receives some of the signal on coil 32 via paths 80. Power detector 84 measures the power level of the signal received over paths 80. Power detector 84 outputs a detection signal NFOUT when the power level of the signal received over paths 80 exceeds a threshold power level TH. Control circuitry 16 (FIG. 1) may set threshold power level TH and may adjust threshold power level TH over time if desired.

Power detector 84 may measure the power of the signal received over paths 80 concurrent with digital I/Q data measurement by demodulation chain 82 and/or may measure the power of the signal received over paths 80 while demodulation chain 82 is inactive. When demodulation chain 82 is inactive and inverter 26 is not transmitting wireless power signals 44, inverter 26 or other circuitry may transmit a series of one or more low power pings over coil 32 (e.g., while in a standby mode). The low power pings may be, for example, low power card detection (LPCD) pings (pulses) transmitted using an associated LPCD ping periodicity. The low power pings may be calibrated using a free air calibration procedure if desired. In the free air calibration procedure, demodulation chain 82 is adjusted/calibrated such that the measured I/Q data is zero (e.g., canceling the free air transmit-only response), and the magnitude and phase of the coil and corresponding resonant network are set as the no-RX reference.

Power detector 84 measures the signal produced on coil 32 in response to the low power pings to monitor for another device being added to the system. When an external electromagnetic field is produced on coil 32 (e.g., via near-field coupling (NFC) from another WPT system or an NFC device such as an RFID tag or reader in close proximity to coil 32), the power of the signal produced on coil 32 in response to the low power pings will be different than in the absence of the external electromagnetic field. As such, power detector 84 detects the presence of the external electromagnetic field (and thus another WPT system or NFC device in close proximity to coil 32) based on the power of the signal measured in response to the low power pings. In other words, power detector 84 outputs detection signal NFOUT with first value when the external electromagnetic field is present and with a second value when the external electromagnetic field is not present.

For example, when a power receiving coil (e.g., coil 48 of a first PRX device) is near-field coupled to the coil 32 in a first PTX device in a first WPT system 8, the coupling between the coils results in a reflected impedance appearing in series with coil 32. The reflected impedance is a combination of the impedance of coil 48, the impedance of tuning circuitry coupled to coil 48, and the impedance of the rectifier coupled to coil 48. During a low power ping, the presence of coil 48 results in significant magnitude and phase change of the voltages and currents on the transmitting side of the resonant network (e.g., at coil 32). The magnitude and phase are such that power transfer occurs, with the transmitting coil delivering power to the receiving coil and charging a capacitor on the PRX device. When a second wireless power transmitting coil is present (e.g., the coil 32 of a second PTX device from a second WPT system) and delivering power to a corresponding power receiving coil (e.g., the coil 48 of a second PRX device from the second WPT system), the field generated by the second PTX device couples into the coil 32 of the first PTX device, inducing a voltage in series with the coil. In this scenario, the magnitude and phase of the voltages and currents in the first PTX device are significantly altered because the second PTX device is delivering some wireless power to the first PTX device. The amplitude of the currents and voltages in the first PTX device may, for example, be significantly lower than on the second PTX device (e.g., when the second PTX device is an affecter device). This ensures the presence of the second WPT system is dominant and distinct to the free air or single TX/RX response of the first WPT system.

Presence of the external electromagnetic field could be indicative of the corresponding PRX device 24 in close proximity to coil 32 or another device such as an NFC device or another WPT system. When power detector 84 detects that the external electromagnetic field is present (e.g., an electromagnetic field having oscillations at radio frequencies), inverter 26 may then transmit a series of digital pings over coil 32 (e.g., of increasing magnitude each greater than the magnitude of the low power pings). The digital pings may help to ensure a reliable attachment/detachment detection of the corresponding PRX device and/or may help an affecter system to detect an affected system. If PTX device 12 receives a suitable acknowledgement or response to the digital pings (e.g., an in-band or out-of-band handshake acknowledgement to the digital pings), this is indicative of the external electromagnetic field being produced by the corresponding PRX device 24 and inverter 26 may then transmit wireless power signals 44 to PRX device 24 using coil 32. If the PTX device does not receive a suitable acknowledgment or response to the digital pings, this is indicative of the external electromagnetic field being produced by a different device and inverter 26 may forego transmission of wireless power signals 44. Inverter 26 may continue to periodically transmit the series of digital pings and/or low power pings until an acknowledgement is received.

Measurement circuitry 18 may use demodulation chain 82 and/or power detector 84 to detect the presence of another WPT system 8 in close proximity to coil 32. Control circuitry 16 may take suitable action when measurement circuitry 18 detects another WPT system 8 in close proximity to coil 32.

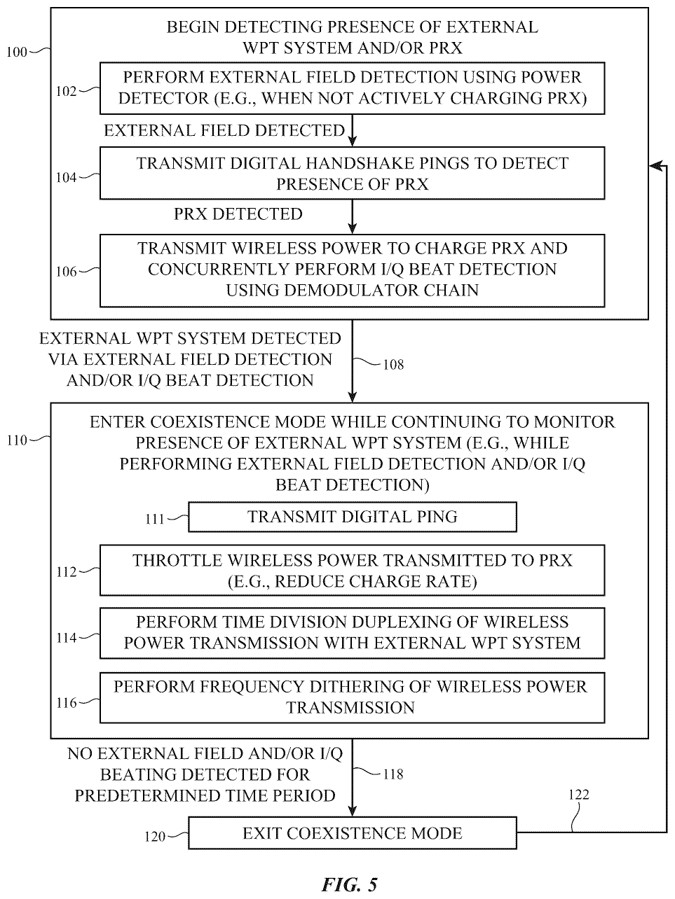

FIG. 5 is a flow chart of illustrative operations that are performed by a first PTX device 12 (e.g., having wireless power transmitting circuitry 22 and measurement circuitry 18 of FIG. 4) of a first WPT system 8 to mitigate wireless charging interruptions at or produced by a second WPT system 8 in close proximity to the coil 32 of the first PTX device 12. The first PTX device 12 may charge a corresponding first PRX device 24 of the first WPT system 8 when the first PRX device 24 is mounted to the first PTX device 12.

The second WPT system 8 includes a second PTX device 12. The second PTX device 12 may charge a corresponding second PRX device 24 of the second WPT system 8 when the second PRX device 24 is mounted to the second PTX device 12. The second WPT system 8 may sometimes be referred to herein as an external WPT system 8. The second PTX device 12 may sometimes be referred to herein as an external PTX device. The second PRX device 24 may sometimes be referred to herein as an external PRX device. The operations of FIG. 5 may, for example, be performed by PTX device 12A of FIG. 3 (e.g., the first PTX device may be an affecter PTX device in affecter WPT system 8A) and/or by PTX device 12B of FIG. 3 (e.g., the first PTX device may an affected PTX device in affected WPT system 8B). While described herein as being performed by the first PTX device 12 of the first WPT system 8, the operations of FIG. 5 may be concurrently performed by the second PTX device 12 of the second WPT system 8.

At operation 100, the first PTX device 12 begins detecting (monitoring for) the presence of the second WPT system 8. If the first PRX device 24 is placed onto the first PTX device 12 (e.g., overlapping coil 32), the first PTX device may also wirelessly charge the first PRX device by using coil 32 to transmit wireless power signals 44 to the first PRX device.

At an initial time, the first PTX device 12 has no knowledge of whether the first PRX device 24 is present overlapping coil 32. The first PTX device 12 uses measurement circuitry 18 to detect the presence of the first PRX device 24 overlapping coil 32. At the same time, the first PTX device 12 may also use measurement circuitry 18 to detect the presence of the second WPT system 8 in close proximity to coil 32.

For example, at operation 102, the first PTX device 12 performs external electromagnetic field detection using power detector 84. Inverter 26 may transmit a series of low power pings using coil 32. Power detector 84 measures, via paths 80, the power of the signal produced on coil 32 in response to the low power pings. Power detector 84 detects the presence or absence of an external electromagnetic field produced at coil 32 based on the signal measured over paths 80 (e.g., based on the power of the signal produced on the coil in response to the low power pings due to an impedance mismatch between the coil and its surroundings). Power detector 84 detecting an external electromagnetic field at coil 32 could be indicative of the first PRX device 24 being located over coil 32, an NFC device or foreign object being located over coil 32, and/or the second WPT system 8 being located in close proximity to coil 32 (e.g., where the second WPT system 8 produces electromagnetic signal leakage onto coil 32).

To distinguish between the first PRX device 24 and other external objects, when power detector 84 detects the external electromagnetic field at coil 32, processing proceeds to operation 104 and inverter 26 then transmits a series of one or more digital pings (e.g., handshake pings) using coil 32. When the first PRX device 24 successfully receives a digital ping, the first PRX device transmits a handshake ping response or acknowledgement (e.g., using in-band or out-of-band communications). The first PTX device 12 detects the presence of the first PRX device 24 overlapping coil 32 based on receipt of the handshake ping response or acknowledgement (e.g., when the handshake ping response is successfully received).

The first PTX device 12 determines that the first PRX device 24 is not present overlapping coil 32 when the first PTX device 12 does not receive a handshake ping response or acknowledgement within a predetermined time period. In these situations, the external electromagnetic field detected at coil 32 may be due to the presence of the second WPT system 8 in close proximity to coil 32 (e.g., the first PTX device 12 may detect or determine that the second WPT system 8 is present in close proximity to coil 32) or may be due to the presence of an NFC device or other foreign object overlapping coil 32.

On the other hand, first PTX device 12 determines that the first PRX device 24 is present overlapping coil 32 when the first PTX device 12 receives the handshake ping response or acknowledgement. In these situations, processing proceeds to operation 106. At operation 106, inverter 26 on the first PTX device 12 proceeds with transmitting wireless power signals 44 to the first PRX device 24 using coil 32. At the same time, demodulator chain 82 measures signals on coil 32 via paths 80. Demodulator chain 82 processes the measured signals to detect when the second WPT system 8 is in close proximity to coil 32. For example, demodulator chain 82 may detect the presence of beating in the digital I/Q data output by ADC 100. The first PTX device 12 detects or determines that the second WPT system 8 is present in close proximity to coil 32 when beating is present in the digital I/Q data at a corresponding beat frequency (e.g., as shown by curve 90 of plot 86 in FIG. 4). The first PTX device 12 may detect that beating is present when there is a single beat or more than a threshold number of beats per unit time in the digital I/Q data. On the other hand, the first PTX device 12 detects or determines that the second WPT system 8 is not present in close proximity to coil 32 when beating is not present or when there are fewer than the threshold number of beats per unit time in the digital I/Q data at a corresponding beat frequency (e.g., as shown by curve 88 of plot 86 in FIG. 4). Additionally or alternatively, demodulator chain 82 may receive in-band communications from the first PRX device 24 via coil 32.

When the first PTX device 12 detects the presence of the second WPT system 8 in close proximity to coil 32, processing proceeds to operation 110 via path 108. In other words, processing proceeds from operation 100 to operation 110 via path 108 in response to the first PTX device 12 detecting the presence of the second WPT system 8 in close proximity to coil 32.

The first PTX device 12 may detect the presence of the second WPT system 8 based on the presence of beating in the digital I/Q data output by demodulator chain 82 (e.g., when the first PTX device 12 is concurrently transmitting wireless power 44 to the first PRX device 24) and/or based on the output of power detector 84 (e.g., when the first PTX device 12 is not concurrently transmitting wireless power 44 to the first PRX device 24).

At operation 110, the first PTX device 12 enters a coexistence mode with the second WPT system 8 that is in close proximity to coil 32. While in the coexistence mode, the first PTX device 12 may transmit wireless power signals 44 if and when the first PRX device 24 is present overlapping coil 32 or may forego transmission of wireless power signals 44 when the first PRX device 24 is not present overlapping coil 32, when the first PRX device 24 is fully charged or asleep, and/or when the first PTX device 12 is operating in a sleep or cloak mode. While in the coexistence mode, the first PTX device 12 continues to monitor (detect) the presence or absence of the second WPT system 8 in close proximity to coil 32 (e.g., by detecting beating in the digital I/Q data using demodulation chain 82 while concurrently transmitting wireless power signals 44 and/or by detecting the presence of the external electromagnetic field at coil 32 using power detector 84 when not concurrently transmitting wireless power signals 44).

In the coexistence mode, the first PTX device 12 and/or the second PTX device 12 in the second WPT system 8 take one or more actions to coordinate coexistence of the first WPT system and the nearby second WPT system. For example, the first WPT system 8 may perform one or more of operations 111, 112, 114, and/or 116 while in coexistence mode. The first WPT system 8 may perform two or more of operations 111, 112, 114, and 116 concurrently if desired.

At operation 111, the inverter 26 on first PTX device 12 transmits a series of one or more digital pings. The first PTX device 12 may, for example, transmit the series of digital pings (handshake pings) when the transmission of wireless power signals 44 is restarted upon detection of the second WPT system 8 in close proximity to coil 32. The first PTX device 12 may receive a handshake ping acknowledgement from the first PRX device 24 and may then continue to transmit wireless power signals 44 to the first PRX device 24 responsive to receipt of the handshake ping acknowledgement.

At operation 112, the first PTX device 12 throttles or reduces the amount of wireless power (e.g., the magnitude of wireless power signals 44) transmitted to the first PRX device 24 using coil 32. The first PTX device 12 may reduce the amount of wireless power by reducing the charging rate of the first PRX device 24 (e.g., by reducing the duty cycle of inverter 26). This reduction in power helps to prevent interruption of potential wireless power transfer by the second WPT system 8 due to electromagnetic fields from coil 32 onto the second WPT system 8.

At operation 114, the first PTX device 12 performs time division duplexing of wireless power transmission with the second PTX device 12 in the second WPT system. In performing the time division duplexing, the first PTX device 12 and the second PTX device 12 utilize one or more timers to alternate between which of the first PTX device and the second PTX device transmits wireless power signals 44 at any given time (e.g., ensuring that only a single one of first PTX device 12 and the second PTX device 12 transmits wireless power signals 44 at any given time). Transmitting wireless power signals 44 using only a single one of the first and second WPT systems at a time serves to prevent the interruption of wireless power transfer by the first and/or second WPT systems due to electromagnetic leakage between the first and second WPT systems.

At operation 116, the first PTX device 12 performs frequency dithering for the transmitted wireless power signals 44. This involves spreading the frequency spectrum of wireless power signals 44 in a manner that mitigates the production of beating on the wireless power signals conveyed by the second WPT system 8.

When the second WPT system 8 is no longer present overlapping coil 32, processing proceeds to operation 120 via path 118. For example, processing may proceed to operation 120 via path 118 responsive to demodulator chain 82 detecting no beating in the measured digital I/Q data for a first predetermined time period (e.g., five seconds) and/or responsive to power detector 84 detecting no external electromagnetic field at coil 32 for a second predetermined time period (e.g., during a period associated with LPCD ping transmission).

At operation 120, the first PTX device 12 exits the coexistence mode. The first PTX device 12 may reverse one or more of the operations 111, 112, 114, or 116 performed while operating in the coexistence mode. This may serve to boost the wireless charging efficiency of the first PRX device 24 without risk of charging interruption due to the second WPT system, since the second WPT system is no longer present in close proximity to coil 32. Processing then loops back to operation 100 via path 122 to continue to perform wireless charging while monitoring for the presence of the second WPT system.

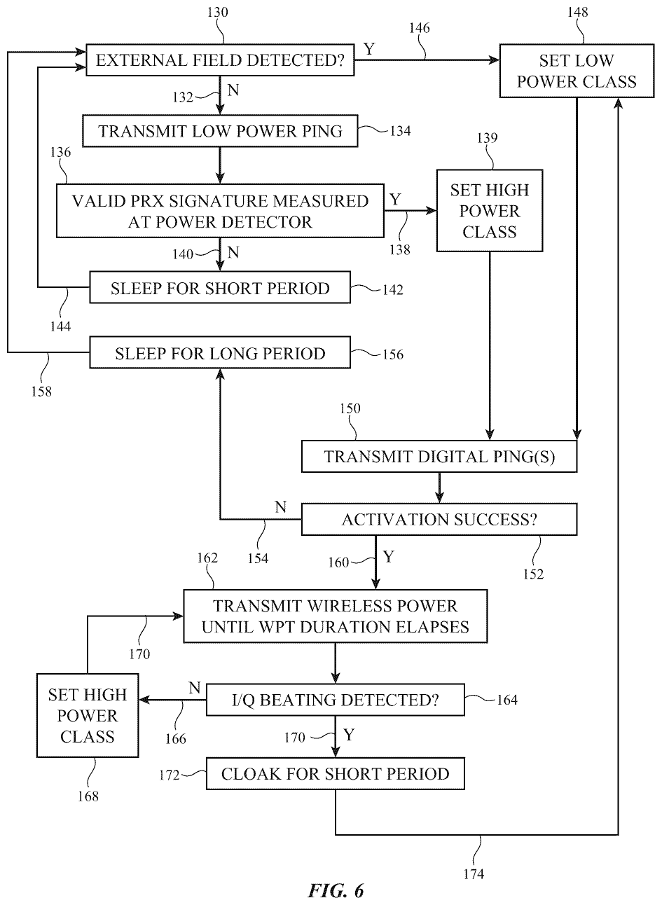

FIG. 6 is a flow chart of illustrative operations performed by the first PTX device 12 using a closed loop power control. The operations of FIG. 6 may, for example, be performed by first PTX device 12 while processing operations 102-106 and operation 112 of FIG. 5. First PTX device 12 may perform operations 130-156 as part of a low power ping operation (e.g., an LPCD operation) while processing operation 102 of FIG. 5, may perform operations 150-152 as part of a digital ping or handshake operation while processing operation 104 of FIG. 5, and may perform operations 162-172 as part of a closed loop power control/adjustment operation while processing operations 106 and 112 of FIG. 5.

At operation 130, control circuitry 16 on first PTX device 12 determines or detects whether an external electromagnetic field is present at coil 32 (e.g., based on the output of power detector 84). If the external electromagnetic field is not present at coil 32 (e.g., if the control circuitry detects that the external electromagnetic field is absent from coil 32), processing proceeds to operation 134 via path 132.

At operation 134, inverter 26 transmits a low power ping (e.g., an LPCD pulse) using coil 32. Power detector 84 measures the signal produced at coil 32 over paths 80 in response to the low power ping.

At operation 136, control circuitry 16 determines whether the signal measured by power detector 84 responsive to the low power ping exhibits a characteristic or signature (e.g., a predetermined power level) that is consistent with the presence of the first PRX device 24 overlapping coil 32. If the signal measured by power detector 84 is consistent with the presence of the first PRX device 24 overlapping coil 32 (e.g., if power detector 84 measures a valid PRX signature in the signal produced in response to the low power ping), processing proceeds to operation 139 via path 138.

At operation 139, control circuitry 16 sets or configures inverter 26 to transmit subsequent wireless power signals 44 using a relatively high amount of power (e.g., using a high power class). Processing then proceeds from operation 139 to operation 150.

On the other hand, if the signal measured by power detector 84 is not consistent with the presence of the first PRX device 24 overlapping coil 32 (e.g., if power detector 84 measures an invalid PRX signature in the signal produced in response to the low power ping), processing proceeds from operation 136 to operation 142 via path 140.

At operation 142, control circuitry 16 configures inverter 26 and/or other portions of wireless power transmitting circuitry 22 to sleep (e.g., to forego transmission of any signals over coil 32) for a relatively short period (e.g., 100 ms). Processing then loops back to operation 130 via path 144. If power detector 84 detects an external electromagnetic field at coil 32 while processing operation 130, processing proceeds from operation 130 to operation 148 via path 146.

At operation 148, control circuitry 16 sets or configures inverter 26 to transmit subsequent wireless power signals 44 using a relatively low amount of power (e.g., using a low power class). Since power detector 84 detecting the external electromagnetic field at coil 32 could be indicative of the presence of either the first PRX device 24 or the second WPT system 8 overlapping coil 32, setting inverter 26 in the low power class helps to ensure that the first WPT system 8 will not interrupt wireless power transfer by the second WPT system 8 in the event that the external electromagnetic field at coil 32 is produced by the second WPT system 8.

Processing then proceeds from operation 148 to operation 150.

At operation 150, inverter 26 on the first PTX device 12 transmits a series (set) of one or more digital pings (e.g., digital handshake pings) using coil 32. The first PTX device 12 listens for a response or acknowledgement to the digital pings. Since the first PRX device 24 will transmit a suitable response or acknowledgement to the digital pings if present overlapping coil 32 (whereas the second WPT system 8 will not transmit a suitable response or acknowledgement to the digital pings), the digital pings may allow the first PTX device 12 to determine whether the detected external electromagnetic field on coil 32 was produced by the first PRX device 24 or the second WPT system 8 (e.g., to determine whether the first PRX device 24 or the second WPT system 8 is present overlapping coil 32).

At operation 152, control circuitry determines or detects whether wireless charging activation using the digital pings was successful. Wireless charging activation is successful when the first PTX device 12 receives a valid response or acknowledgement to the transmitted digital ping(s) from the first PRX device 24. Wireless charging activation is not successful when the first PTX device 12 does not receive a valid response or acknowledgement to the transmitted digital ping(s) from the first PRX device 24 within a predetermined time period and/or after a predetermined number of transmissions of the series of digital pings. If wireless charging activation is not successful, processing proceeds to operation 156 via path 154.

At operation 156, control circuitry 16 configures inverter 26 and/or other portions of wireless power transmitting circuitry 22 to sleep (e.g., to forego transmission of any signals over coil 32) for a relatively long period (e.g., a period greater than the short period associated with operation 142, such as 1 second or greater). Processing then loops back to operation 130 via path 158 to transmit additional low power pings and/or digital pings. If power detector 84 detects an external electromagnetic field at coil 32 at operation 130, processing proceeds from operation 130 to operation 148 via path 146. If wireless charging activation is successful, processing proceeds from operation 152 to operation 162 via path 160.

When charging activation is successful, the first PTX device 12 has successfully detected the first PRX device 24 overlapping coil 32. At operation 162, the first PTX device 12 transmits wireless power signals 44 using coil 32 to power/charge first PRX device 24. The first PTX device 12 continues to transmit wireless power signals until a predetermined time period (sometimes referred to herein as a WPT duration) elapses. Demodulation chain 82 measures the signal on coil 32 and generates corresponding digital I/Q data while the first PTX device 12 transmits wireless power signals 44. Once the WPT duration elapses, processing proceeds to operation 164.

At operation 164, control circuitry 16 may determine or detect whether beating (e.g., a beat signal at a corresponding beat frequency) is present in the digital I/Q data generated by demodulation chain 82. If no beating (beat signal) or fewer than a threshold number of beats are present in the digital I/Q data during the WPT duration, this is indicative of the second WPT system 8 not being present in close proximity to coil 32 and processing may proceed to operation 168 via path 166.

At operation 168, control circuitry 16 increases the amount of power transferred in wireless power signals 44 or otherwise configures inverter 26 to transmit subsequent wireless power signals 44 using a relatively high amount of power (e.g., using the high power class). desired, control circuitry 16 may remove a VDDPA capacitor from use in transmitting the wireless power signals. Since the absence of a beat signal is indicative of the absence of the second WPT system 8 in close proximity to coil 32, increasing the magnitude of wireless power signals 44 in this way serves to maximize wireless power transfer efficiency for the first PRX device 24 without interrupting charging of the second WPT system 8. Processing then loops back to operation 162 via path 170. If beating (e.g., a beat signal) or more than a threshold number of beats are present in the digital I/Q data during the WPT duration, this is indicative of the second WPT system 8 being present in close proximity to coil 32 and processing may proceed from operation 164 to operation 172 via path 170.

At operation 172, first PTX device 12 enters a cloak mode for a relatively short time period (e.g., 100 ms). In the cloak mode, control circuitry 16 configures inverter 26 and/or other portions of wireless power transmitting circuitry 22 to sleep (e.g., to forego transmission of any signals over coil 32) for the relatively short time period. The absence of wireless power transmission in the cloak mode serves to prevent interruption of wireless power transfer at the second WPT system 8 in close proximity to coil 32. Processing then loops back to operation 148 via path 174. In this way, the first PTX device 12 may use the presence or absence of a beat signal in the digital I/Q data to perform closed loop power control in the transmission of wireless power signals 44 in a manner that optimizes the wireless charging efficiency of the first PRX device 24 while concurrently mitigating any potential charging interruption at the second WPT system 8.

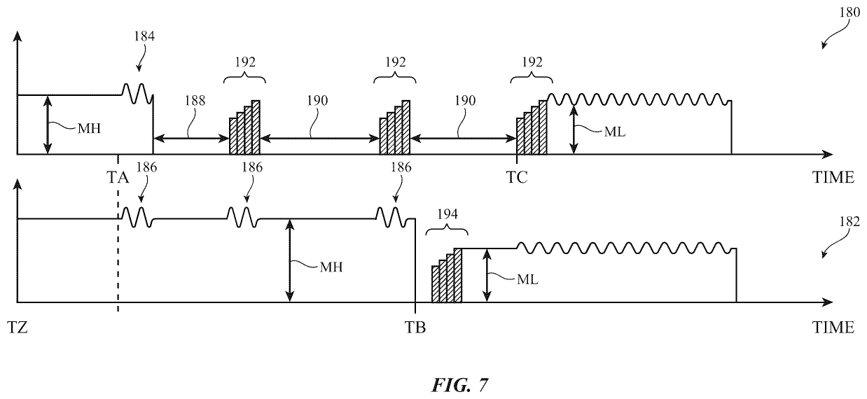

FIGS. 7-10 are timing diagrams that illustrate the charging operations of the first WPT system 8 (e.g., WPT system 8A of FIG. 3) and the second WPT system 8 (e.g., WPT system 8B of FIG. 3) under four different usage scenarios. In the examples of FIGS. 7-10, WPT systems 8A and 8B reduce the amount of transmitted wireless power to mitigate charging interruptions (e.g., the timing diagrams of FIGS. 7-10 illustrate the operation of WPT systems 8A and 8B when each of the first and second WPT systems performs the operations of FIG. 6 and operations 100, 110, 112, and 120 of FIG. 5). The examples of FIGS. 7-10 illustrate a situation in which first WPT system 8A acts as an affecter WPT system and where second WPT system 8B acts as an affected WPT system. First WPT system 8A is therefore sometimes referred to below as affecter system 8A whereas second WPT system 8B is sometimes referred to below as affected system 8B.

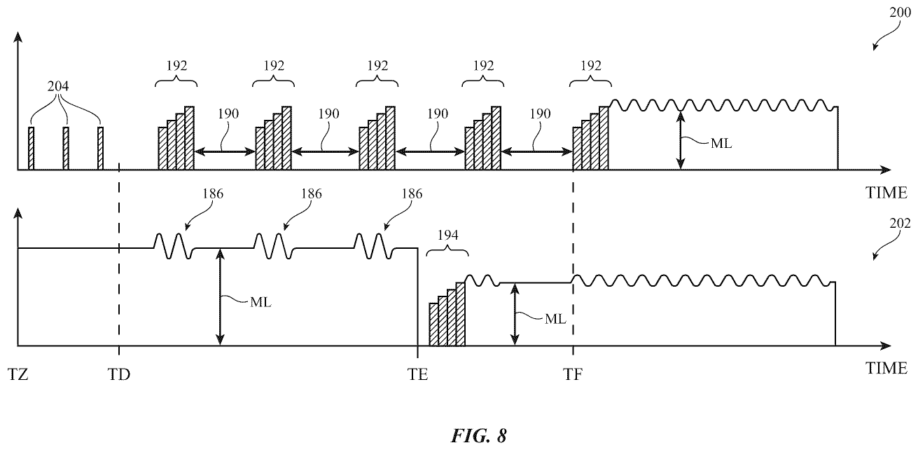

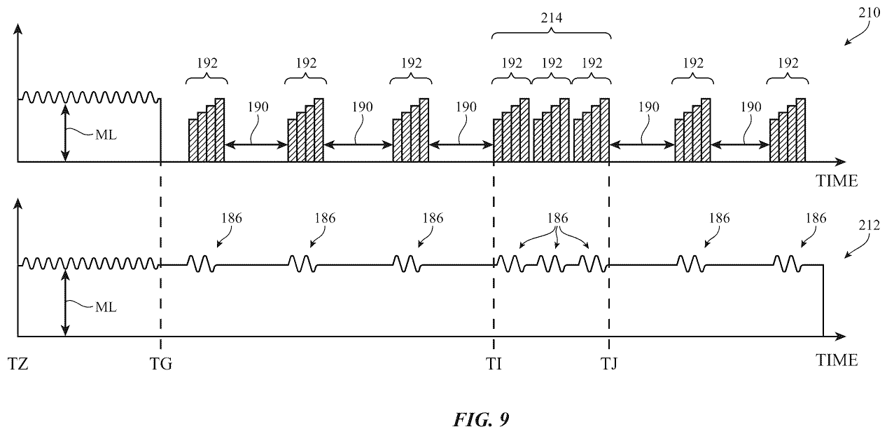

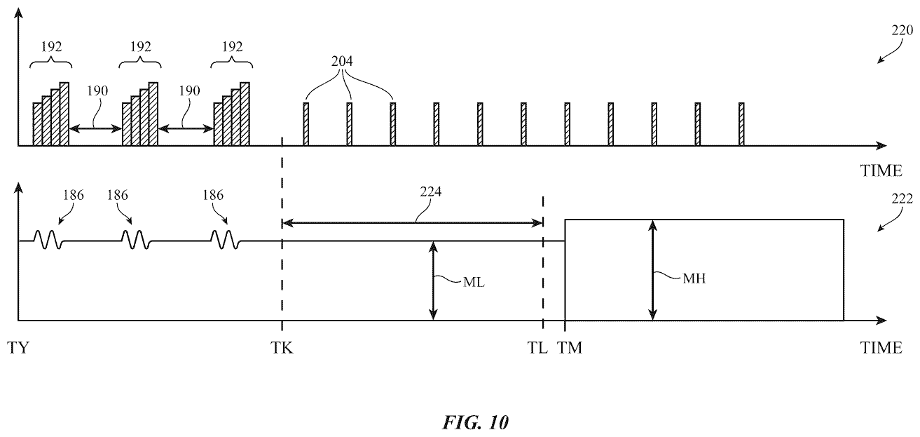

Timing diagram 180 of FIG. 7, timing diagram 200 of FIG. 8, timing diagram 210 of FIG. 9, and timing diagram 220 of FIG. 10 plot the operation of affected system 8B over time. The vertical axis of timing diagrams 180, 200, 210, and 220 plots the magnitude of signals transmitted by the second PTX device 12B in affected system 8B on its corresponding coil 32. Timing diagram 182 of FIG. 7, timing diagram 202 of FIG. 8, timing diagram 212 of FIG. 9, and timing diagram 222 of FIG. 10 plot the operation of affecter system 8A over time. The vertical axis of timing diagrams 182, 202, 212, and 222 plots the magnitude of signals transmitted by the first PTX device 12A in affecter system 8A on its corresponding coil 32.

The timing diagrams of FIG. 7 illustrate charging operations in a usage scenario where affected system 8B is brought into close proximity to affecter system 8A after affecter system 8A has already begun wirelessly charging first PRX device 24A and after affected system 8B has already begun wirelessly charging second PRX device 24B (e.g., a dual charging scenario).

At an initial time TZ, affected system 8B is not located in close proximity to affecter system 8A (e.g., affected system 8B is located relatively far such as more than a threshold distance (e.g., 10 mm) away from affecter system 8A). As shown by timing diagram 180, at initial time TZ, the second PTX device 12B in affected system 8B transmits wireless power signals 44B (FIG. 3) to the second PRX device 24B in affected system 8B. As shown by timing diagram 180, at initial time TZ, the first PTX device 12A in affecter system 8A concurrently transmits wireless power signals 44A (FIG. 3) to the first PRX device 24A in affecter system 8A. Since systems 8A and 8B are located relatively far away from each other, both first PTX device 12A and second PTX device 12B transmit wireless power signals with a relatively high magnitude MH (e.g., with a relatively high amount of power, at a relatively high power level, with a relatively high charging rate, and/or with relatively high inverter duty cycle).

At a subsequent time TA, affected system 8B is brought into close proximity to affecter system 8A. For example, affected system 8B may be placed on top of affecter system 8A (e.g., as shown in FIG. 3). The close proximity of systems 8A and 8B causes radio-frequency leakage from affecter system 8A onto the coil 32 of the second PTX device 12B in affected system 8B, producing an electromagnetic beat 184 (e.g., a beat signal, component, ripple, or envelope) at the coil 32 of second PTX device 12B. At the same time, radio-frequency leakage from affected system 8B onto the coil 32 of the first PTX device 12A in affecter system 8A produces an electromagnetic beat 186 (e.g., a beat signal, component, ripple, or envelope) at the coil 32 of first PTX device 12A.

Since system 8B is the affected system in this example, the beat 184 produced at second PTX device 12B impacts wireless power transfer performance in the transmission of wireless power signals 44B by second PTX device 12B. During time period 188, second PTX device 12B transmits a low power ping (e.g., while processing operation 102 of FIG. 5 and/or operation 134 of FIG. 6). Since second PRX device 24B is present overlapping the coil 32 of second PTX device 12B, the power detector 84 on second PTX device 12B measures/detects a valid PRX signature in response to the low power ping (e.g., proceeding from operation 136 to operation 139 of FIG. 6). Second PTX device 12B then transmits a series of digital pings 192 (e.g., while processing operation 104 of FIG. 5 and/or operation 150 of FIG. 6). Alternatively, second PTX device 12B may proceed directly to digital ping transmission after resetting wireless power transfer (e.g., without transmitting any low power pings).

The transmission of each series of digital pings 192 by second PTX device 12B produces a corresponding beat 186 at the coil 32 in the first PTX device 12A of affecter system 8A. However, since affecter system 8A has not experienced a wireless power transfer interruption in this example (as the affecter system), first PTX device 12A is able to continue transmitting wireless power signals 44A to charge first PRX device 24A.

On the other hand, the transmission of wireless power signals 44A at relatively high magnitude MH by first PTX device 12A prevents second PTX device 12B from successfully receiving an acknowledgement or response from second PRX device 24B to the series of digital pings 192. As such, second PTX device 12B continues to re-transmit the series of digital pings 192 after a relatively long duration 190 (e.g., while processing operation 156 of FIG. 6) until second PTX device 12B successfully receives an acknowledgement or response from second PRX device 24B to one or more of the digital pings.

The demodulation chain 82 on first PTX device 12A of affecter system 8A detects each beat 186 produced at first PTX device 12A by the transmission of each series of digital pings 192 by second PTX device 12B. First PTX device 12A may, for example, include a counter that increments every time first PTX device 12A measures a beat 186. Once first PTX device 12A has measured more than a threshold number of beats 186, first PTX device 12A enters coexistence mode (e.g., at operation 110 of FIG. 5 and/or proceeding from operation 164 to operation 172 of FIG. 6).

In the example of FIG. 7, the threshold number of beats 186 is two. As such, once first PTX device 12A has measured three beats 186, first PTX device 12A enters coexistence mode (e.g., at time TB). In the coexistence mode, first PTX device 12A restarts wireless power transfer by waiting for a short duration (e.g., a cloaking period at operation 172 of FIG. 6) and then transmitting a series of digital pings 194 (e.g., while processing operation 111 of FIG. 5 and/or operation 150 of FIG. 6 after a first loop back to operation 150 from operation 172 via path 174 and operation 148 of FIG. 6).

First PTX device 12A successfully receives an acknowledgement or response to digital pings 194 from first PRX device 24A. First PTX device 12A then begins transmitting wireless power signals 44A with a relatively low magnitude ML (e.g., with a relatively low amount of power, at a relatively low power level, with a relatively low charging rate, and/or with relatively low inverter duty cycle) less than relatively high magnitude MH (e.g., since first PTX device 12A sets a low power class at operation 148 before transmission of digital pings 194).

The relatively low magnitude ML of the wireless power signals 44A transmitted by first PTX device 12A in the coexistence mode is sufficiently low so as not to prevent second PTX device 12B in affected system 8B from successfully receiving a response or acknowledgement to digital pings 192 from second PRX device 24B. As such, second PTX device 12B successfully receives a response or acknowledgement to the digital pings 192 transmitted at time TC while first PTX device 12A is in the coexistence mode. Second PTX device 12B, then itself in the coexistence mode, transmits wireless power signals 44B at relatively low magnitude ML to second PRX device 24B (e.g., while processing operation 162 after one iteration of operation 148 of FIG. 6). Since PTX devices 12A and 12B both concurrently transmit wireless power signals 44 while in close proximity to each other, beats are produced at both PTX devices 12A and 12B. However, the relatively low magnitude ML of the transmitted wireless power signals 44A and 44B promotes coexistence of first PTX device 12A and second PTX device 12B.

The timing diagrams of FIG. 8 illustrate charging operations in a usage scenario where affected system 8B is brought into close proximity to affecter system 8A after affecter system 8A has already begun wirelessly charging first PRX device 24A but prior to affected system 8B beginning to wirelessly charge second PRX device 24B.

Affected system 8B is located in close proximity to affecter system 8A at initial time TZ. As shown by timing diagram 202, beginning at initial time TZ, the first PTX device 12A in affecter system 8A transmits wireless power signals 44A to the first PRX device 24A in affecter system 8A at relatively high magnitude MH (e.g., while processing operation 106 of FIG. 5). As shown by timing diagram 200, affected system 8B does not transmit wireless power signals 44B to the second PRX device 24B at this time (e.g., because second PRX device 24B has not yet been mounted to second PTX device 12B). Instead, second PTX device 12B transmits a series of low power pings 204 to detect the presence of an external electromagnetic field at its coil 32 (e.g., while processing operation 102 of FIG. 5).

At time TD, the power detector 84 on second PTX device 12B detects an external electromagnetic field at its coil 32. Second PTX device 12B has no a priori knowledge of whether the external electromagnetic field is produced by second PRX device 24B or affecter system 8A. As such, second PTX device 12B begins to transmit one or more series of digital pings 192 while listening for a response to the digital pings from second PRX device 24B (e.g., while processing operation 104 of FIG. 5 and/or operation 150 of FIG. 6). In the absence of a response to the digital pings, second PTX device 12B re-transmits digital pings 192 after every period 190 has elapsed. The transmission of each series of digital pings 192 produces a respective beat 186 on the coil 32 of first PTX device 12A.

The demodulation chain 82 on first PTX device 12A measures (detects) and counts beats 186. Once first PTX device 12A has measured more than a threshold number of beats 186, first PTX device 12A enters coexistence mode (e.g., at operation 110 of FIG. 5 and/or proceeding from operation 164 to operation 172 of FIG. 6). In the example of FIG. 8, the threshold number of beats 186 is two. As such, once first PTX device 12A has measured three beats 186, first PTX device 12A enters coexistence mode (e.g., at time TE). In the coexistence mode, first PTX device 12A restarts wireless power transfer by waiting for a short duration (e.g., a cloaking period at operation 172 of FIG. 6) and then transmitting a series of digital pings 194 (e.g., while processing operation 111 of FIG. 5 and/or operation 150 of FIG. 6 after a first loop back to operation 150 from operation 172 via path 174 and operation 148 of FIG. 6).

First PTX device 12A successfully receives an acknowledgement or response to digital pings 194 from first PRX device 24A. First PTX device 12A then begins transmitting wireless power signals 44A with a relatively low magnitude ML. The relatively low magnitude ML of the wireless power signals 44A transmitted by first PTX device 12A in the coexistence mode is sufficiently low so as not to prevent second PTX device 12B in affected system 8B from successfully receiving a response or acknowledgement to digital pings 192 from second PRX device 24B.

At time TF, the second PRX device 24B of affected system 8B is mounted to second PTX device 12B (e.g., as shown by arrow 70 of FIG. 3). As such, second PTX device 12B successfully receives a response or acknowledgement to the digital pings 192 transmitted at time TE while first PTX device 12A is in the coexistence mode. Second PTX device 12B, then itself in the coexistence mode, transmits wireless power signals 44B at relatively low magnitude ML to power/charge second PRX device 24B (e.g., while processing operation 162 after one iteration of operation 148 of FIG. 6). Since PTX devices 12A and 12B both concurrently transmit wireless power signals 44 while in close proximity to each other, beats are produced at both PTX devices 12A and 12B. However, the relatively low magnitude ML of the transmitted wireless power signals 44A and 44B promotes coexistence of both first PTX device 12A and second PTX device 12B.

The timing diagrams of FIG. 9 illustrate charging operations in a usage scenario where affected system 8B is brought into close proximity to affecter system 8A after affecter system 8A has already begun wirelessly charging first PRX device 24A in the coexistence mode and after affected system 8B has already begun wirelessly charging second PRX device 24B in the coexistence mode, but where second PTX device 12B enters a sleep cloak mode.

At initial time TZ, affected system 8B is already in close proximity to affecter system 8A, first PRX device 24A is mounted to first PTX device 12A, and second PRX device 24B is mounted to second PTX device 12B. First PTX device 12A transmits wireless signals 44A with relatively low magnitude ML to charge first PRX device 24A while second PTX device 12B concurrently transmits wireless signals 44B with relatively low magnitude ML to charge second PRX device 24B (e.g., the PTX devices have already reduced the power level of the wireless power signals by processing one or more of the operations of FIGS. 5 and 6 so as not to interrupt wireless charging by either WPT system).

As shown by timing diagram 210, at time TG, second PTX device 12B enters a sleep cloak mode. This may occur, for example, when second PRX device 24B has become fully charged. In the sleep cloak mode, second PTX device 12B no longer transmits wireless power signals 44B but continues to transmit series of digital pings 192 every period 190. While fully charged, second PRX device 24B transmits a response/acknowledgement to digital pings 192 that identifies that second PRX device 24B is fully charged. Since second PRX device 24B is fully charged, second PTX device 12B does not transmit wireless power signals 44B to second PRX device 24B in response to receiving the response/acknowledgement, thereby conserving power.

As shown by timing diagram 212, the transmission of each series of digital pings 192 by second PTX device 12B produces a respective beat 186 on the coil 32 of first PTX device 12A (e.g., while first PTX device 12A is already in coexistence mode). However, the power level of digital pings 192 is sufficiently low such that beats 186 do not impact wireless charging failure performance interruption at first PTX device 12A.

At time TI, second PRX device 24B is removed from second PTX device 12B (e.g., to provide user input to the display on second PTX device 12B). As such, second PTX device 12B does not receive a response to the digital pings 192 transmitted at time TI. Second PTX device 12B then continues to re-transmit the series of digital pings 192 for a predetermined number of times (e.g., transmits a burst 214 of multiple series of digital pings 192 until time TJ). If no response/acknowledgement is received from second PRX device 24B after transmission of burst 214, second PRX device 24B determines/detects that second PRX device 24B has been detached from second PTX device 12B. Second PTX device 12B may notify the system to begin inking and/or may perform any other desired operations (e.g., may continue to transmit digital pings 192 after every period 190, may transmit low power pings, etc.).

The timing diagrams of FIG. 10 illustrate charging operations in a usage scenario where affected system 8B is moved away from affecter system 8A while affecter system 8A is transmitting wireless power signals 44A in coexistence mode and while second PTX device 12B is in sleep cloak mode. The timing diagrams of FIG. 10 may, for example, correspond to operations that occur after time TJ of FIG. 9.

At initial time TY (e.g., at or after time TJ of FIG. 9), affected system 8B is already in close proximity to affecter system 8A, first PRX device 24A is mounted to first PTX device 12A, and second PRX device 24B is mounted to second PTX device 12B. First PTX device 12A transmits wireless signals 44A with relatively low magnitude ML to charge first PRX device 24A while second PTX device 12B is concurrently in sleep cloak mode. As shown by timing diagram 220, in the sleep cloak mode, second PTX device 12B transmits series of digital pings 192 every period 190. As shown by timing diagram 222, the transmission of each series of digital pings 192 by second PTX device 12B produces a respective beat 186 on the coil 32 of first PTX device 12A. Demodulation chain 82 on first PTX device 12A detects and counts the beats 186 produced on coil 32. However, the power level of digital pings 192 is sufficiently low such that beats 186 do not impact wireless power transfer performance at first PTX device 12A.

At time TK, affected system 8B is moved out of close proximity to affecter system 8A. This eliminates the external electromagnetic field produced at second PTX device 12B by the wireless power signals 44A transmitted by first PTX device 12A. Second PTX device 12B thereafter reverts to transmitting low power pings (e.g., LPCD pulses) rather than digital pings 192.

After time TK, since affected system 8B is no longer in close proximity to first PTX device 12A, second PTX device 12B no longer produces beats 186 on the coil 32 of first PTX device 12A. If demodulation circuit 82 of first PTX device 12A does not measure any beats 186 for at least a predetermined duration 224 (e.g., from time TK to time TL, for a predetermined number of WPT cycles such as 20 WPT cycles, around 1.5 seconds, 5 seconds, etc.), first PTX device 12A determines that affected system 8B is no longer in close proximity to first PTX device 12A. Responsive to detecting that affected system 8B is no longer in close proximity to first PTX device 12A, first PTX device 12A exits coexistence mode at time TM (e.g., at operation 120 of FIG. 5). In exiting coexistence mode, first PTX device 12A increases the power of wireless power signals 44A to relatively high magnitude MH (e.g., beginning at time TM, first PTX device 12A begins transmitting wireless power signals 44A at relatively high magnitude MH). This serves to maximize the charging efficiency of first PRX device 24A (thereby minimizing charge time) without impact to wireless charging performance at affecter system 8A or affected system 8B.

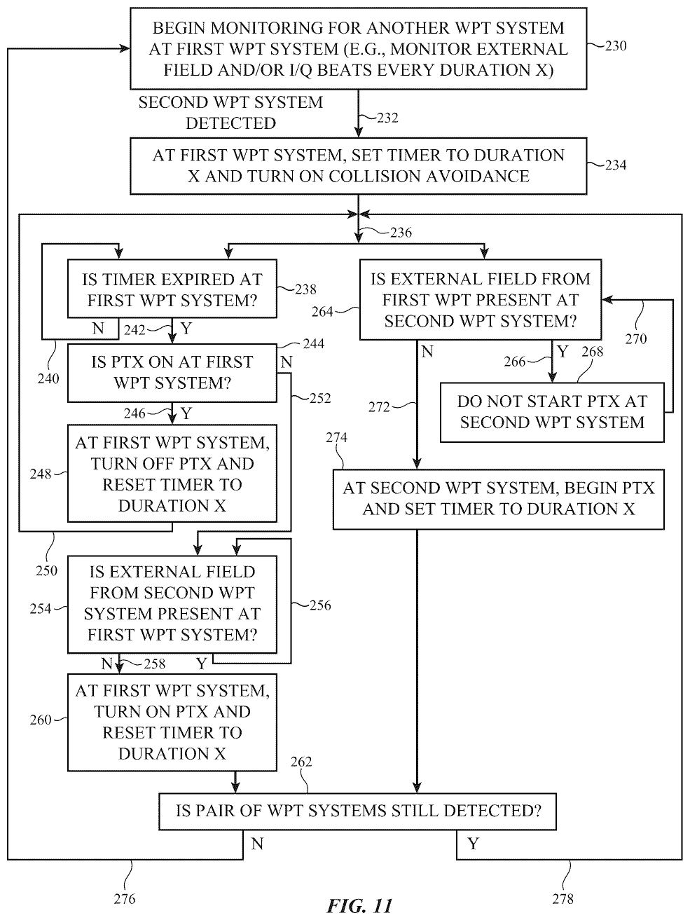

FIG. 11 is a flow chart of illustrative operations performed by first WPT system 8A and second WPT system 8B (either of which may be the affecter or affected system) to improve coexistence using a time division duplexing (TDD) scheme. The operations of FIG. 11 may, for example, be performed while processing operation 114 of FIG. 4. Operations 230-234 and 238-262 are performed by first WPT system 8A. Operations 264-262 are performed by second WPT system 8B. The TDD scheme may be performed in addition to or instead of the power level reduction scheme associated with operation 112 (FIG. 5), operations 162-172 (FIG. 6), and FIGS. 7-10.

At operation 230, first WPT system 8A begins monitoring for the presence of second WPT system 8B in close proximity to first PTX device 12A (e.g., using demodulation chain 82 and/or power detector 84 of FIG. 4). When first WPT system 8A detects second WPT system 8B in close proximity to first PTX device 12A, processing proceeds to operation 234 via path 222 (e.g., corresponding to the advancement from operation 100 to operation 110 via path 108 of FIG. 5).

At operation 234, first PTX device 12A of first WPT system 8A sets a timer to a duration X and begins monitoring for the presence of the external electromagnetic field at its coil 32 for duration X (a procedure sometimes referred to herein as collision avoidance). Processing then proceeds to operation 238 (performed at first PTX device 12A of first WPT system 8A) and operation 264 (performed at second PTX device 12B of second WPT system 8B) in parallel (concurrently).

At operation 238, the control circuitry on first PTX device 12A determines or detects whether the timer has expired (e.g., whether duration X has elapsed). If the timer has not expired, first PTX device 12A continues to wait until the time expires (as shown by loopback path 240). Once the timer has expired, processing proceeds to operation 244 via path 242.

At operation 244, the control circuitry on first PTX device 12A determines or detects whether inverter 26 is transmitting wireless power signals 44A over its coil 32 to charge first PRX device 24A (e.g., whether wireless power transmission is on). If first PTX device 12A is transmitting wireless power signals 44A (e.g., when wireless power transmission is on), processing proceeds to operation 248 via path 246.

At operation 248, the control circuitry on first PTX device 12A turns off wireless power transmission (e.g., controls inverter 26 to stop transmitting wireless power signals 44A) and resets the timer to duration X. Processing then loops back to path 236 via path 250. On the other hand, if first PTX device 12A is not transmitting wireless power signals 44A at operation 244 (e.g., when wireless power transmission is off), processing proceeds from operation 244 to operation 254 via path 252.

At operation 254, power detector 84 on first PTX device 12A measures the coil 32 of first PTX device 12A and the control circuitry on first PTX device 12A determines, based on the output of power detector 84, whether an external electromagnetic field from second PTX device 12B of second WPT system 8B is present at the coil 32 of first PTX device 12A. If the external electromagnetic field is present, first PTX device 12A continues to monitor the external electromagnetic field, as shown by loopback path 256. When first PTX device 12A does not detect the external electromagnetic field, processing proceeds to operation 260 via path 258.

At operation 260, the control circuitry on first PTX device 12A turns on wireless power transmission (e.g., controls inverter 26 to begin transmitting wireless power signals 44A) and resets the timer to duration X. Processing then proceeds to operation 262.

At operation 262, the control circuitry on first PTX device 12A determines whether second WPT system 8B or another pair of WPT systems are present in close proximity to first PTX device 12A. If none of these other devices or systems are present, processing loops back to operation 230 via path 276. If one or more of these other devices or systems are present, processing loops back to path 236 via path 278.

Meanwhile, at operation 264, the power detector 84 on second PTX device 12B measures the coil 32 of second PTX device 12B and the control circuitry on second PTX device 12B determines, based on the output of power detector 84, whether an external electromagnetic field from first PTX device 12A of first WPT system 8A is present at the coil 32 of second PTX device 12B. If the external electromagnetic field is present, processing proceeds to operation 268 via path 266.

At operation 266, the control circuitry on second PTX device 12B controls inverter 26 to forego transmission of wireless power signals 44B (e.g., second PTX device 12B does not start wireless power transmission). Processing then loops back to operation 264 via path 270 until the external electromagnetic field is no longer present. This helps to ensure that second PTX device 12B does not transmit wireless power signals 44B concurrent with transmission of wireless power signals 44A at first PTX device 12A, thereby mitigating any potential interruption to wireless power transmission. If the external electromagnetic field is not present at the coil 32 of second PTX device 12B, processing proceeds to operation 274 via path 272.

At operation 274, the control circuitry on second PTX device 12B turns on wireless power transmission (e.g., controls inverter 26 to begin transmitting wireless power signals 44B) and sets its timer to duration X. Processing then proceeds to operation 262. Since no external electromagnetic field is present at second PTX device 12B at this time, second PTX device 12B determines that first PTX device 12A is not transmitting first wireless signals 44A and can thereby transmit second wireless signals 44B without impacting wireless charging at first PTX device 12A. In this way, the first and second PTX devices can alternate transmission of wireless power signals 44A and 44B each for the duration of timer X. This helps to ensure that each PTX device can successfully transmit wireless power to its respective PRX device.

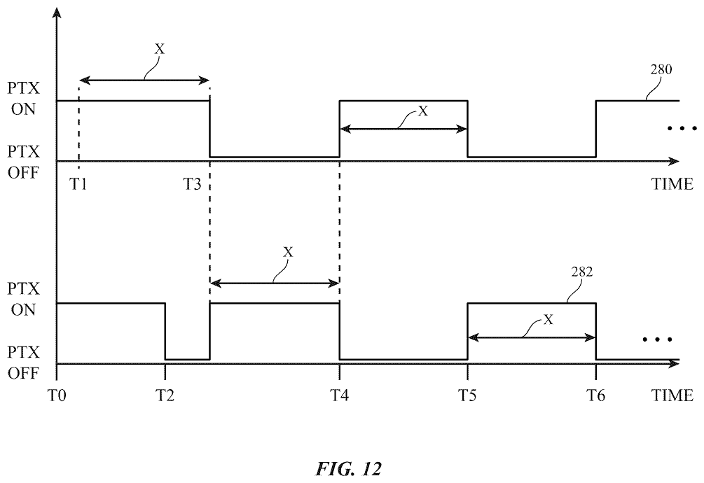

FIG. 12 is a timing diagram showing the TDD scheme that may be used by first PTX device 12A and second PTX device 12B (e.g., while processing the operations of FIG. 11). Curve 282 illustrates the wireless power transmission timing of second PTX device 12B. Curve 280 illustrates the wireless power transmission timing of first PTX device 12A.

At time T0, first PTX device 12A transmits wireless power signals 44A concurrent with second PTX device 12B transmitting wireless power signals 44B (e.g., PTX is on for both PTX devices). As shown by curve 280, at time T1, first PTX device 12A begins its timer of duration X. At time T2, electromagnetic fields from the transmission of wireless power signals 44A by first PTX device 12A onto the coil of second PTX device 12B produces excessive beating on the coil of second PTX device 12B, interrupting wireless power transmission at second PTX device 12B (e.g., causing second PTX device 12B to reset its wireless charging). In this example, first PTX device 12A acts as the affecter device whereas second PTX device 12B acts as the affected device.

After the timer of duration X has elapsed at first PTX device 12A (e.g., at time T3), first PTX device 12A stops transmitting wireless power signals 44A for a subsequent duration X (e.g., power transmission is off PTX device 12B from time T3 until time T4). At time T3, second PTX device 12B begins to transmit wireless power signals 44B for duration X. Since first PTX device 12A does not transmit wireless power signals 44A during this period, second PTX device 12B transmits wireless power signals 44B without beating and without risk of charging interruption. Once duration X has elapsed at second PTX device 12B (e.g., at time T4), second PTX device 12B switches power transmission off and first PTX device 12A then switches power transmission on. First PTX device 12A and second PTX device 12B continue to alternate wireless power transmission in this way, thereby permitting wireless charging of both of the WPT systems while they are in close proximity to each other.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent with.”

It is desirable for PTX device 12 and PRX device 24 to be able to communicate certain information such as received power to control wireless power transfer. However, the above-described technology need not involve the transmission of personally identifiable information in order to function. Out of an abundance of caution, it is noted that to the extent that implementations of this wireless charging technology involve the use of personally identifiable information, implementers should follow privacy policies and practices that are generally recognized as meeting or exceeding industry or governmental requirements for maintaining the privacy of users.

The foregoing is merely illustrative and various modifications can be made to the described embodiments. The foregoing embodiments may be implemented individually or in any combination.

What is claimed is:

1. An electronic device in a first wireless power system operable in proximity to a second wireless power system, the first wireless power system including a first power receiving device, the second wireless power system including a power transmitting device and a second power receiving device, and the electronic device comprising:
a wireless power transfer coil;
an inverter coupled to the wireless power transfer coil and configured to transmit a wireless power signal to the first power receiving device using the wireless power transfer coil; and
a demodulation chain coupled to the wireless power transfer coil, wherein the demodulation chain is configured to detect a beat signal produced on the wireless power transfer coil by the power transmitting device while the inverter transmits the wireless power signal, the inverter being configured to adjust the wireless power signal based on the beat signal detected by the demodulation chain.

2. The electronic device of claim 1, wherein the inverter is configured to adjust the wireless power signal by reducing a magnitude of the wireless power signal responsive to detection of the beat signal by the demodulation chain.

3. The electronic device of claim 1, wherein the inverter is configured to adjust the wireless power signal by transmitting, responsive to detection of the beat signal by the demodulation chain, the wireless power signal using a time division duplexing scheme with the power transmitting device.

4. The electronic device of claim 1, wherein the inverter is configured to adjust the wireless power signal by frequency dithering the wireless power signal responsive to detection of the beat signal by the demodulation chain.

5. The electronic device of claim 1, further comprising:
a power detector coupled to the wireless power transfer coil in parallel with the demodulation chain, wherein the power detector is configured to measure a signal power at the wireless power transfer coil and the inverter is configured to adjust the wireless power signal based on the signal power measured by the power detector.

6. The electronic device of claim 1, wherein the demodulation chain comprises:
a preamplifier;
a mixer coupled to an output of the preamplifier;
an adder coupled to an output of the mixer;
a baseband amplifier coupled to an output of the adder; and
an analog-to-digital converter (ADC) coupled to an output of the baseband amplifier, wherein the beat signal comprises an in-phase and quadrature-phase (I/Q) beat signal, the mixer comprises an I/Q mixer, the adder comprises an I/Q adder, the baseband amplifier comprises an I/Q amplifier, and the ADC comprises an I/Q ADC.

7. The electronic device of claim 1, wherein the inverter is configured to reset transmission of the wireless power signal responsive to detection, by the demodulation chain, of a predetermined number of beats in the beat signal, wherein the inverter is configured to transmit the wireless power signal at a first magnitude prior to resetting transmission of the wireless power signal, the inverter is configured to transmit a series of digital pings using the wireless power transfer coil after resetting transmission of the wireless power signal, and the inverter is configured to transmit the wireless power signal at a second magnitude lower than the first magnitude after transmitting the series of digital pings.

8. The electronic device of claim 1, wherein the electronic device comprises:
a housing having peripheral conductive sidewalls;
a display mounted to the peripheral conductive sidewalls; and
a dielectric window in the peripheral conductive sidewalls and overlapping the wireless power transfer coil, wherein the first power receiving device comprises a computer stylus mountable to the peripheral conductive sidewalls and overlapping the dielectric window.

9. The electronic device of claim 8, wherein the electronic device comprises a first tablet computer, the power transmitting device comprises a second tablet computer, and the second power receiving device comprises an additional computer stylus mountable to the second tablet computer.

10. The electronic device of claim 1, wherein the wireless power signal is at a frequency approximately equal to 13.56 MHz.

11. The electronic device of claim 1, wherein the beat signal is generated at the wireless power transfer coil based on the wireless power signal and electromagnetic energy produced by the power transmitting device in the second wireless power system, and wherein the beat signal comprises an envelope of a superposition of the wireless power signal transmitted by the inverter and the electromagnetic energy produced by the power transmitting device in the second wireless power system, the electromagnetic energy having a different frequency than the wireless power signal.

12. A method of operating a first power transmitting device to wirelessly charge a power receiving device in proximity to a second power transmitting device, the method comprising:
detecting, using a power detector coupled to a wireless power transfer coil, whether an external radio-frequency (RF) field produced by the second power transmitting device is present at the wireless power transfer coil;
transmitting, using an inverter and the wireless power transfer coil, a wireless power signal to the power receiving device at a first power level responsive to the power detector detecting that the external electromagnetic field is present at the wireless power transfer coil; and
transmitting, using the inverter and the wireless power transfer coil, the wireless power signal to the power receiving device at a second power level responsive to the power detector detecting that the external electromagnetic field is absent from the wireless power transfer coil, wherein the second power level is greater than the first power level.

13. The method of claim 12, further comprising:
transmitting, using the inverter and the wireless power transfer coil, a ping signal responsive to the power detector detecting that the external electromagnetic field is absent from the wireless power transfer coil.

14. The method of claim 13, further comprising:
measuring, using the power detector, a power level produced at the wireless power transfer coil responsive to the ping signal;
transmitting the wireless power signal to the power receiving device at the first power level responsive to the measured power level having a first magnitude; and
transmitting the wireless power signal to the power receiving device at the second power level responsive to the measured power level having a second magnitude different from the first magnitude.

15. The method of claim 14, further comprising:
transmitting, using the inverter and the wireless power transfer coil, a series of digital pings responsive to the power detector detecting that the external electromagnetic field is present at the wireless power transfer coil; and
transmitting the wireless power signal responsive to receipt, from the power receiving device, of an acknowledgement to the series of digital pings.

16. The method of claim 12, further comprising:
measuring, using a demodulation chain that is different than the power detector, a signal on the wireless power transfer coil concurrent with transmission of the wireless power signal at the second power level; and
reducing a power level of the wireless power signal responsive to detection of beating in the signal measured by the demodulation chain.

17. The method of claim 12, further comprising:
measuring, using a demodulation chain that is separate from the power detector, a signal on the wireless power transfer coil concurrent with transmission of the wireless power signal at the first power level; and
increasing a power level of the wireless power signal responsive to an absence of beating in the signal measured by the demodulation chain over a predetermined time period.

18. A non-transitory computer-readable storage medium storing one or more programs configured to be executed by one or more processors of a first power transmitting device of a first wireless charging system operable in proximity to a second wireless charging system, the first wireless charging system having a first power receiving device, the second wireless charging system having a second power transmitting device and a second power receiving device, and the one or more programs including instructions for:
transmitting a wireless power signal to the first power receiving device using a wireless power transfer coil in the first power transmitting device;
detecting a presence of the second wireless charging system in proximity to the coil based on a measurement of the wireless power transfer coil while the wireless power transfer coil transmits the wireless power signal to the first power receiving device;
stopping transmission of the wireless power signal when a predetermined time period has elapsed since detection of the presence of the second wireless system; and
resuming transmission of the wireless power signal when the predetermined time period has elapsed since stopping transmission of the wireless power signal.

19. The non-transitory computer-readable storage medium of claim 18, further comprising:
foregoing, for the predetermined time period, transmission of the wireless power signal when the predetermined time period has elapsed since resuming transmission of the wireless power signal.

20. The non-transitory computer-readable storage medium of claim 19, wherein detecting the presence of the second wireless charging system comprises detecting an in-phase and quadrature-phase (I/Q) beat signal on the coil.
